(19) United States
(12) Patent Application Publication
(10) Pub. No.: US 2026/0132274 A1
(43) Pub. Date: May 14, 2026

(54) TIRE COMPONENT FROM RUBBER COMPOSITION INCLUDING GUAYULE RUBBER AND EUTECTIC COMPOSITION AND RELATED METHODS

(71) Applicant: Bridgestone Americas Tire Operations, LLC, Nashville, TN (US)

(72) Inventor: Shammi Ahmed, Copley, OH (US)

(73) Assignee: Bridgestone Americas Tire Operations, LLC, Nashville, TN (US)

(21) Appl. No.: 18/698,996

(22) PCT Filed: Oct. 6, 2022
(86) PCT No.: PCT/US2022/077691

§ 371 Date: Apr. 5, 2024

Related U.S. Application Data
(60) Provisional application No. 63/252,682, filed on Oct. 6, 2021.

(51) Int. Cl. C08L 7/00; B60C 1/00; B60C 11/00; C08K 3/06; C08K 5/19; C08K 5/21

(52) U.S. Cl. CPC C08L 7/00; B60C 1/0016; B60C 11/0008; C08K 3/06; C08K 5/19; C08K 5/21; B60C 2011/0025; C08L 2312/00

(57) ABSTRACT

Disclosed herein are tire components comprising a rubber composition including guayule natural rubber and optionally at least one conjugated diene monomer-based rubber; about 30 to about 150 phr of reinforcing filler selected from carbon black and silica; and a cure package including a sulfur-based vulcanizing agent, at least one vulcanization accelerator, a vulcanization activator, and a eutectic composition or a residue thereof. Also disclosed are related methods for providing or preparing the tire component and/or the rubber composition thereof.

### FIELD

The present application is directed to a tire component comprising a rubber composition including guayule natural rubber and a eutectic composition to related methods.

### BACKGROUND

Guayule natural rubber is sourced from guayule plant (Parthenium argentatum) which is a woody shrub-like plant that produces rubber and resin. A eutectic composition refers to a mixtures of ingredients which can self-associate (e.g., through hydrogen bond interactions) to form a eutectic mixture which has a melting point lower than that of each individual ingredient. Such eutectic mixtures are often referred to a deep eutectic solvents (DES).

### SUMMARY

Disclosed herein is a tire component comprising a rubber composition including guayule natural rubber and a eutectic composition. Also disclosed are related methods for providing or preparing the tire component.

In a first embodiment, a method is disclosed for providing a tire component, preferably a tire tread. The method of first embodiment comprises preparing a rubber composition comprising: (a) 100 parts of at least one rubber including (i) 10-100 parts of natural rubber, preferably 51-90 parts of natural rubber with at least 10% by weight provided by a guayule natural rubber having a Mw of at least 1.2 million grams/mole, preferably 1.25 to 1.35 grams/mole, an Mn of at least 0.25 million grams/mole, preferably 0.3 to 0.4 million grams/mole and a Mw/Mn of 3-4 million grams/mole and up to 90% by weight provided by a Hevea natural rubber, and (ii) 0-90 parts, preferably 10-49 parts of at least one conjugated diene monomer-based rubber; (b) about 30 to about 150 phr of reinforcing filler selected from carbon black and silica; and (c) a cure package including a sulfur-based vulcanizing agent, at least one vulcanization accelerator, a vulcanization activator, and a eutectic composition, preferably in an amount of about 0.005 to about 3 phr, more preferably about 0.01 to about 1 phr. wherein (a), (b) and (c) are used in a cured rubber composition to provide the tire component.

In a second embodiment, a tire component, preferably a tire tread, comprising a rubber composition is provided. The rubber composition comprises: (a) 100 parts of at least one rubber including (i) 10-100 parts, preferably 51-90 parts of natural rubber with at least 10% by weight provided by a guayule natural rubber having a Mw of at least 1.2 million grams/mole, preferably 1.25 to 1.35 grams/mole, an Mn of at least 0.25 million grams/mole, preferably 0.3 to 0.4 million grams/mole and a Mw/Mn of 3-4, and (ii) 0-90 parts, preferably 10-49 parts of at least one conjugated diene monomer-based rubber; (b) about 30 to about 150 phr of reinforcing filler selected from carbon black and silica; and (c) a cure package including a sulfur-based vulcanizing agent, at least one vulcanization accelerator, a vulcanization activator, and a eutectic composition or a residue thereof, preferably in an amount of about 0.005 to about 3 phr, more preferably about 0.01 to about 1 phr, wherein (a), (b) and (c) are used in a cured rubber composition to provide the tire component.

### DETAILED DESCRIPTION

Disclosed herein is a tire component comprising a rubber composition including guayule natural rubber and a eutectic composition. Also disclosed are related methods for providing or preparing the tire component.

In a first embodiment, a method is disclosed for providing a tire component, preferably a tire tread. The method of first embodiment comprises preparing a rubber composition comprising: (a) 100 parts of at least one rubber including (i) 10-100 parts of natural rubber, preferably 51-90 parts of natural rubber with at least 10% by weight provided by a guayule natural rubber having a Mw of at least 1.2 million grams/mole, preferably 1.25 to 1.35 grams/mole, an Mn of at least 0.25 million grams/mole, preferably 0.3 to 0.4 million grams/mole and a Mw/Mn of 3-4 million grams/mole and up to 90% by weight provided by a Hevea natural rubber, and (ii) 0-90 parts, preferably 10-49 parts of at least one conjugated diene monomer-based rubber; (b) about 30 to about 150 phr of reinforcing filler selected from carbon black and silica; and (c) a cure package including a sulfur-based vulcanizing agent, at least one vulcanization accelerator, a vulcanization activator, and a eutectic composition, preferably in an amount of about 0.005 to about 3 phr, more preferably about 0.01 to about 1 phr. wherein (a), (b) and (c) are used in a cured rubber composition to provide the tire component.

In a second embodiment, a tire component, preferably a tire tread, comprising a rubber composition is provided. The rubber composition comprises: (a) 100 parts of at least one rubber including (i) 10-100 parts, preferably 51-90 parts of natural rubber with at least 10% by weight provided by a guayule natural rubber having a Mw of at least 1.2 million grams/mole, preferably 1.25 to 1.35 grams/mole, an Mn of at least 0.25 million grams/mole, preferably 0.3 to 0.4 million grams/mole and a Mw/Mn of 3-4, and (ii) 0-90 parts, preferably 10-49 parts of at least one conjugated diene monomer-based rubber; (b) about 30 to about 150 phr of reinforcing filler selected from carbon black and silica; and (c) a cure package including a sulfur-based vulcanizing agent, at least one vulcanization accelerator, a vulcanization activator, and a eutectic composition or a residue thereof, preferably in an amount of about 0.005 to about 3 phr, more preferably about 0.01 to about 1 phr, wherein (a), (b) and (c) are used in a cured rubber composition to provide the tire component.

### Definitions

The terminology as set forth herein is for description of the embodiments only and should not be construed as limiting the invention as a whole.

As used herein, the term “BR” or “polybutadiene” refers to homopolymer of 1,3-butadiene.

As used herein, the term “majority” refers to more than 50% (e.g., at least 50.1%, at least 5.5%, at least 51%, etc.).

As used herein, the term “minority” refers to less than 50% (e.g., no more than 49.5%, no more than 49%, etc.).

Unless otherwise indicated herein, the term “Mooney viscosity” refers to the Mooney viscosity, ML¹⁺⁴. As those of skill in the art will understand, a rubber composition's Mooney viscosity is measured prior to vulcanization or curing.

As used herein, the abbreviation Mn is used for number average molecular weight.

As used herein, the abbreviation Mw is used for weight average molecular weight.

As used herein, the term “natural rubber” means naturally occurring rubber such as can be harvested from sources such as Hevea rubber trees and non-Hevea sources (e.g., guayule shrubs and dandelions such as TKS). In other words, the term “natural rubber” should be construed so as to exclude synthetic polyisoprene.

As used herein, the term “phr” means parts per one hundred parts rubber. The one hundred parts rubber is also referred to herein as 100 parts of an elastomer component.

As used herein the term “polyisoprene” means synthetic polyisoprene. In other words, the term is used to indicate a polymer that is manufactured from isoprene monomers, and should not be construed as including naturally occurring rubber (e.g., Hevea natural rubber, guayule-sourced natural rubber, or dandelion-sourced natural rubber). However, the term polyisoprene should be construed as including polyisoprenes manufactured from natural sources of isoprene monomer.

As used herein the term “SBR” means styrene-butadiene copolymer rubber.

As used herein, the term “tread,” is meant to encompass both the portion of a tire that comes into contact with the road under normal inflation and load as well as any subtread.

### Natural Rubber

As discussed above, according to the first and second embodiments disclosed herein, the rubber composition includes 100 parts of at least one rubber which includes (i) 10-100 parts of natural rubber (e.g., 10, 20, 30, 40, 50, 60, 70, 80, 90, or 100 parts), preferably 51-90 parts (e.g., 51, 55, 60, 65, 70, 75, 80, 85, 90, 95 or 100 parts) of natural rubber. By stating that the natural rubber is present in an amount of 10-100 parts in the rubber composition is meant that the natural rubber can be present in an amount of 10 parts and up to all 100 parts of the overall rubber in the rubber composition. The 100 parts of at least one rubber as well as the parts of guayule natural rubber refer to parts by weight.

Of the total amount of natural rubber (i), at least 10% by weight is provided by a guayule natural rubber as described below. In preferred embodiments of the first and second embodiments, an increased percentage by weight of the natural rubber (i) is provided by a guayule natural rubber as described below, including at least 30% by weight (e.g., 30%, 40%, 50%, 60%, 70%, 80%, 90% or even 100% by weight), more preferably at least 40% by weight (e.g., 40%, 50%, 60%, 70%, 80%, 90% or even 100% by weight). In certain embodiments of the first and second embodiments, at least 50% by weight of the natural rubber (i) is provided by a guayule natural rubber as described below. As well, it is specifically envisioned that in certain embodiments of the first and second embodiments, that the entirely of the natural rubber (i) (i.e., 100% by weight) is made up of a guayule natural rubber as described below.

### Guayule Natural Rubber

As discussed above, according to the first and second embodiments disclosed herein, at least 10% by weight of the natural rubber (i) in the rubber composition comprises a guayule natural rubber guayule natural rubber. According to the first and second embodiments, the guayule natural rubber has a Mw of at least 1.2 million grams/mole (e.g., 1.2 million, 1.25 million, 1.3 million, 1.35 million, 1.4 million, 1.45 million, etc.) and a Mn of at least 0.25 million grams/mole (e.g., 0.25 million, 0.3 million, 0.35 million, 0.4 million, 0.45 million, 0.5 million, etc.). In preferred embodiments of the first and second embodiments, the guayule natural rubber has a Mw of 1.25 to 1.35 million grams/mole (e.g., 1.25 million, 1.3 million, or 1.35 million,) and a Mn of 0.3 to 0.4 million grams/mole (e.g., 0.25 million, 0.3 million, or 0.35 million). The Mw and Mn values (and by extension the Mw/Mn values) referred to herein refer to values measured by GPC using a polystyrene standard.

According to the first and second embodiments, the resin content of the guayule natural rubber may vary. In preferred embodiments of the first and second embodiments, the guayule natural rubber has a resin content of about 2 to about 5% by weight or 2 to 5% by weight (e.g., 2, 2.2, 2.4, 2.5, 2.6, 2.8, 3, 3.2, 3.4, 3.5, 3.6, 3.8, 4, 4.2, 4.4, 4.5, 4.6, 4.8, or 5%). According to the first and second embodiments, the ash content of the guayule natural rubber may vary. In preferred embodiments of the first and second embodiments, the guayule natural rubber has an ash content of about 0.1 to about 0.2 weight % or 0.1 to 0.2 weight % (e.g., 0.1, 0.11, 0.12, 0.13, 0.14, 0.15, 0.16, 0.17, 0.18, 0.19, or 0.2%). In particularly preferred embodiments of the first and second embodiments, the guayule natural rubber has a resin content of about 2 to about 5% by weight or 2 to 5% by weight and an ash content of about 0.1 to 0.2 weight % or 0.1 to 0.2 weight %. The resin content of a natural rubber sample can be measured using acetone extraction, and, thus, the term “resin” is used interchangeably with the phrase “acetone extractables.” The resin content of the purified guayule natural rubber can be determined according to the following acetone extraction procedure. A 9-10 gram sample of guayule rubber is soxhlet extracted for 6 hours with co-solvent (31 mL acetone, 170 mL pentane) to solubilize both rubber and resin. Resin is solubilized into the acetone phase. Solubilized rubber (contained within the pentane phase) can be isolated using methanol coagulation, centrifuging and drying. More specifically, 20 mL of the extract from the soxhlet extraction is transferred to a centrifuge tube and 20 mL of methanol is added to coagulate the rubber. The tube and its contents are centrifuged at 1500 rpm for 20 minutes to separate coagulated rubber from solvent. The supernatant within the tube is decanted into a flask and reserved for % resin determination. The tube and its coagulated rubber contents are rinsed with an aliquot of acetone (10 mL) and the acetone is poured out of the tube into the flask containing the decanted supernatant. The remaining coagulated rubber within the tube is then placed into a vacuum oven that is pre heated to 60° C. and dried under vacuum for 30 minutes. After cooling to room temperature, the tube is weighed and the amount of rubber therein is calculated. Resin content (contained within the acetone phase) is determined by utilizing the flask containing the supernatant and decanted acetone. The solvent is evaporated from the flask in a fume hood until near dryness. The remaining contents are then further dried by placing the flask into an oven at 110° C. for 30 minutes. After cooling, the flask is weighed and the amount of resin remaining in the flask is calculated. As used herein the term “ash” (such as used in the connection with the solid purified rubber produced by the processes disclosed herein) means the inorganic material (i.e., free of carbon) that remains after ashing the rubber at 550° C. i 25° C.

According to the first and second embodiments disclosed herein, the Mooney viscosity of the guayule natural rubber may vary. In preferred embodiments of the first and second embodiments, the guayule natural rubber has a ML₁₊₄ at 100° C. of at least 65 (e.g., 65, 66, 67, 68, 69, 70, 71, 72, 73, 74, 75, 76, 77, 78, 79, 80, 82, 83, 84, 85, 86, 87, 88, 89, or 90), more preferably at least 70 (e.g., 70, 71, 72, 73, 74, 75, 76, 77, 78, 79, 80, 82, 83, 84, 85, 86, 87, 88, 89, or 90). It should be understood that according to such embodiments, the ML₁₊₄ at 100° C. can also be within a range encompassed by the foregoing values such as 65-90, preferably 70-90.

In certain embodiments of the first and second embodiments disclosed herein, the guayule natural rubber is functionalized. In such embodiments, the guayule natural rubber is preferably functionalized with a carbon black-reactive functional group, preferably such a functional group as described in detail below with respect to SBRs and BR.

### Additional Rubber(s)

As discussed above, according to the first and second embodiments disclosed herein, the rubber composition includes (ii) 0-90 parts of at least one conjugated diene monomer-based rubber. By stating that the at least one conjugated diene monomer-based rubber (ii) is present in an amount of 0-90 parts (e.g., 0, 5, 10, 15, 20, 25, 30, 35, 40, 45, 50, 55, 60, 65, 70, 75, 80, 85, or 90 parts) in the rubber composition is meant that this at least one conjugated diene monomer-based rubber (ii) is optional, but when present can be present in an amount up to 90 parts of the overall 100 parts of rubber in the rubber composition. The 100 parts of at least one rubber as well as the parts of at least one conjugated diene monomer-based rubber refer to parts by weight. In preferred embodiments of the first and second embodiments, the at least one conjugated diene monomer-based rubber is present in the rubber composition in an amount of 10 to 49 parts (e.g., 10, 15, 20, 25, 30, 35, 40, 45, or 49 parts).

According to the first and second embodiments, the at least one conjugated diene monomer-based rubber (ii) may be a polymer or copolymer made from (a) at least one conjugated diene-based monomer selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene and 2,4-hexadiene, and (b) optionally from at least one vinyl aromatic monomer selected from the group consisting of styrene, α-methyl styrene, p-methylstyrene, o-methylstyrene, p-butylstyrene, vinylnaphthalene, and combinations thereof. In preferred embodiments of the first and second embodiments, the at least one rubber (ii) is selected from the group consisting of styrene-butadiene rubber, polybutadiene rubber, polyisoprene rubber, and mixtures thereof. In certain such embodiments, the at least one rubber (ii) includes polybutadiene. Suitable polybutadienes include high-cis polybutadienes (which can be considered to have a cis-bond content of at least 90%, preferably at least 92%); such high-cis polybutadienes are optionally functionalized. In other embodiments of the first and second embodiments, the at least one rubber (ii) includes styrene-butadiene rubber; such styrene-butadiene rubber is optionally functionalized. In other embodiments of the first and second embodiments, the at least one rubber (ii) includes a combination of polybutadiene (preferably a high-cis polybutadiene) and a styrene-butadiene rubber; in certain such embodiments at least one of the polybutadiene or the styrene-butadiene rubber are functionalized.

In those embodiments of the first and second embodiments wherein the at least one conjugated diene monomer-based rubber includes a functionalized rubber (e.g., functionalized polybutadiene having a cis-1,4-bond content of at least 90% and/or a functionalized SBR), the functional group or groups present may vary. According to preferred embodiments of the foregoing, the functional group used is carbon black-reactive, and in more preferred embodiments the functional group includes a polar group. Non-limiting examples of suitable carbon black reactive functional groups (for BRs and SBRs) include, but are not limited to hydroxyl, carbonyl, ether, ester, halide, amine, imine, amide, nitrile, and oxirane (e.g., epoxy ring) groups. When a functionalized polymeris used, the functional group may be incorporated into the head and/or tail of the polymer and/or may be added along the polymer backbone. Non-limiting examples of functionalized initiators include organic alkaline metal compounds (e.g., an organolithium compound) that additionally include one or more heteroatoms (e.g., nitrogen, oxygen, boron, silicon, sulfur, tin, and phosphorus atoms) or heterocyclic groups containing the foregoing, frequently one or more nitrogen atoms (e.g., substituted aldimines, ketimines, secondary amines, etc.) optionally pre-reacted with a compound such as diisopropenyl benzene. Many functional initiators are known in the art. Exemplary ones are disclosed in U.S. Pat. Nos. 5,153,159, 5,332,810, 5,329,005, 5,578,542, 5,393,721, 5,698,464, 5,491,230, 5,521,309, 5,496,940, 5,567,815, 5,574,109, 5,786,441, 7,153,919, 7,868,110 and U.S. Patent Application Publication No. 2011-0112263, which are incorporated herein by reference. In certain embodiments of the first and second embodiments when a functional initiator is used, a functional nitrogen-containing initiator is utilized; non-limiting examples include cyclic amines, particularly cyclic secondary amines such as azetidine; pyrrolidine; piperidine; morpholine; N-alkyl piperazine; hexamethyleneimine; heptamethyleneimine; and dodecamethyleneimine.

### Eutectic Composition

As discussed above, according to the first and second embodiments, the rubber composition includes a eutectic composition. The particular amount of eutectic composition may vary. In preferred embodiments of the first and second embodiments, the eutectic composition is present in an amount of about 0.005 to about 3 phr or 0.005 to 3 phr (e.g., 0.005, 0.01, 0.05, 0.1, 0.5, 1, 1.5, 2, 2.5, or 3 phr), more preferably in an amount of about 0.01 to about 1 phr or 0.01 to 1 phr (e.g., 0.01, 0.05, 0.1, 0.2, 0.4, 0.5, 0.6, 0.8 or 1 phr).

In one or more embodiments of the first and second embodiments, the eutectic composition is defined by the following formula I:

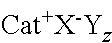

where Cat⁺ is a cation, X⁻ is a counter anion (e.g. Lewis Base), and z refers to the number of Y molecules that interact with the counter anion (e.g. Lewis or Bronsted Acid). As discussed in more detail below, Cat⁺ can include an ammonium, phosphonium, or sulfonium cation; X⁻ may include a halide ion; and Y may include a hydrogen bond donor, a metal halide or a metal halide hydrate. In one or more embodiments of the first and second embodiments, z is a number that achieves a deep eutectic solvent, or in other embodiments a number that otherwise achieves a complex having a melting point lower than the respective eutectic constituents.

In certain embodiments of the first and second embodiments, the eutectic composition comprising a combination of a cationic source and an anionic source. In preferred embodiments of the first and second embodiments, the eutectic composition comprises a combination of a cationic source selected from the group consisting of ammonium compounds, phosphonium compounds, sulfonium compounds, and combinations thereof, and an anionic source selected from the group consisting of metal halide compounds, metal halide hydrate compounds, hydrogen bond donor compounds, and combinations thereof.

In certain embodiments of the first and second embodiments, the eutectic composition includes a cationic source that is selected from ammonium compounds, preferably from at least one of the following: (i) an ammonium compound having the following formula II: (R¹)(R²)(R³)(R⁴)—N+-Φ⁻ where each R¹, R², R³ and R⁴ is independently selected from hydrogen and monovalent organic groups, and two of R¹, R², R³ and R⁴ may be joined to form a divalent organic group and Φ⁻ is a counter anion; (ii) an ammonium compound having formula IV, preferably selected from the group consisting of N-ethyl-2-hydroxy-N,N-dimethylethanaminium chloride, 2-hydroxy-N,N,N-trimethylethanaminium chloride (also known as choline chloride), and N-benzyl-2-hydroxy-N,N-dimethylethanamine chloride, and combinations thereof, or (iii) an ammonium compound having formula III, preferably selected from the group consisting of 2-chloro-N,N,N-trimethylethanaminium (also known as chlorocholine chloride), and 2-(chlorocarbonyloxy)-N,N,N-trimethylethanaminium chloride, and combinations thereof. In certain embodiments of the first and second embodiments, the eutectic composition comprises an anionic source and a cationic source that is an ammonium compound selected from the group described above as (i). In certain embodiments of the first and second embodiments, the eutectic composition comprises an anionic source and a cationic source that is an ammonium compound selected from the group described above as (ii). In certain embodiments of the first and second embodiments, the eutectic composition comprises an anionic source and a cationic source that is an ammonium compound selected from the group described above as (iii).

In certain embodiments of the first and second embodiments, the cationic source is an ammonium compound which includes a quaternary ammonium salt. Useful eutectic compositions using a quaternary ammonium salt include a combination of a quaternary ammonium salt with a metal halide (which are referred to as Type I eutectic composition), a combination of a quaternary ammonium salt and a metal halide hydrate (which are referred to as Type II eutectic composition), a combination of a quaternary ammonium salt and a hydrogen bond donor (which are referred to as Type III eutectic composition), or a combination of a metal halide hydrate and a hydrogen bond donor (which are referred to as Type IV eutectic composition). Analogous combinations of sulfonium or phosphonium in lieu of ammonium compounds can also be employed and can be readily envisaged by those having skill in the art.

In certain embodiments of the first and second embodiments, the quaternary ammonium salt is a solid at 20° C. In these or other embodiments, the metal halide and hydrogen bond donor are solid at 20° C.

In certain embodiments of the first and second embodiments, useful quaternary ammonium salts, which may also be referred to as ammonium compounds, may be defined by the formula II, as discussed above. In certain such embodiments, the counter anion (e.g. Φ⁻) is selected from the group consisting of halide (X⁻), nitrate (NO₃⁻), tetrafluoroborate (BF₄⁻), perchlorate (ClO₄⁻), triflate (SO₃CF₃⁻), trifluoroacetate (COOCF₃⁻). In certain such embodiments, Φ⁻ is a halide ion, and in certain embodiments a chloride ion.

In certain embodiments of the first and second embodiments, when the cationic source is an ammonium compound having formula (II), the monovalent organic groups include hydrocarbyl groups, and the divalent organic groups include hydrocarbylene groups. In certain such embodiments, the monovalent and divalent organic groups include a heteroatom, such as, but not limited to, oxygen and nitrogen, and/or a halogen atom. Accordingly, the monovalent organic groups may include alkoxy groups, siloxy groups, ether groups, and ester groups, as well as carbonyl or acetyl substituents. In certain such embodiments, the hydrocarbyl groups and hydrocarbylene group include from 1 (or the appropriate minimum number) to about 18 carbon atoms, in other embodiments from 1 to about 12 carbon atoms, and in other embodiments from 1 to about 6 carbon atoms. The hydrocarbyl and hydrocarbylene groups may be branched, cyclic, or linear. Exemplary types of hydrocarbyl groups include alkyl, cycloalkyl, aryl and alkylaryl groups. Exemplary types of hydrocarbylene groups include alkylene, cycloalkylene, arylene, and alkylarylene groups. In particular embodiments, the hydrocarbyl groups are selected from the group consisting of methyl, ethyl, octadecyl, phenyl, and benzyl groups. In certain embodiments, the hydrocarbyl groups are methyl groups, and the hydrocarbylene groups are ethylene or propylene group.

Generally, useful types of ammonium compounds for the cationic source in the first and second embodiments include secondary ammonium compounds, tertiary ammonium compounds, and quaternary ammonium compounds. In certain such embodiments, the ammonium compounds include ammonium halides such as, but not limited to, ammonium chloride. In particular embodiments, the ammonium compound is a quaternary ammonium chloride. In certain embodiments of the first and second embodiments when the cationic source is an ammonium compound, R¹, R², R³, and R⁴ are hydrogen, and the ammonium compound is ammonium chloride. In one or more embodiments, the ammonium compounds are asymmetric.

In certain embodiments of the first and second embodiments where the cationic source is an ammonium compound, the ammonium compound includes an alkoxy group and can be defined by the formula III:

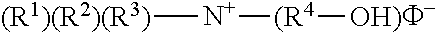

where each R¹, R², and R³ is individually selected from hydrogen or a monovalent organic group, or, in the alternative, two of R¹, R², and R³ join to form a divalent organic group, R⁴ is a divalent organic group, and Φ⁻ is a counter anion. In certain such embodiments, at least one, in other embodiments at least two, and in other embodiments at least three of R¹, R², R³, and are not hydrogen.

Examples of ammonium compounds defined by the formula III include, but are not limited to, N-ethyl-2-hydroxy-N,N-dimethylethanaminium chloride, 2-hydroxy-N,N,N-trimethylethanaminium chloride (which is also known as choline chloride), and N-benzyl-2-hydroxy-N,N-dimethylethanamine chloride.

In certain embodiments of the first and second embodiments, the cationic source is an ammonium compound that includes a halogen-containing substituent and can be defined by the formula IV:

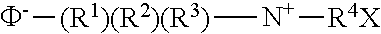

where each R¹, R², and R³ is individually selected from hydrogen or a monovalent organic group, or, in the alternative, two of R¹, R², and R³ join to form a divalent organic group, R⁴ is a divalent organic group, X is a halogen atom, and Φ⁻ is a counter anion. In one or more embodiments, at least one, in other embodiments at least two, and in other embodiments at least three of R¹, R², R³, are not hydrogen. In one or more embodiments, X is chlorine.

Examples of ammonium compounds defined by the formula IV include, but are not limited to, 2-chloro-N,N,N-trimethylethanaminium (which is also referred to as chlorcholine chloride), and 2-(chlorocarbonyloxy)-N,N,N-trimethylethanaminium chloride.

In certain embodiments of the first and second embodiments, the eutectic composition includes a cationic source that is selected from phosphonium compounds. Non-limiting examples of such phosphonium compounds include, but are not limited to, aluminophosphates, cobalt aluminophosphates, and zinc phosphates.

In certain embodiments of the first and second embodiments, the eutectic composition includes a cationic source that is selected from sulfonium compounds. Non-limiting examples of such sulfonium compounds include, but are not limited to, fluorosulfonates, aluminum sulfonates, and zinc sulfonates.

In certain embodiments of the first and second embodiments, the eutectic composition includes an anionic source that is selected from hydrogen bond donor compounds. Various types of hydrogen bond donor compounds may be useful as the anionic source in certain embodiments of the first and second embodiments, including amines, amides, carboxylic acids, and alcohols. In one or more embodiments, the hydrogen-bond donor compound includes a hydrocarbon chain constituent. The hydrocarbon chain constituent may include a carbon chain length including at least 2, in other embodiments at least 3, and in other embodiments at least 5 carbon atoms. In these or other embodiments, the hydrocarbon chain constituent has a carbon chain length of less than 30, in other embodiments less than 20, and in other embodiments less than 10 carbon atoms.

In preferred embodiments of the first and second embodiments when the anionic source is a hydrogen bond donor compound, it is selected from at least one of the following: (i) amines, amides, carboxylic acids, alcohols, and mixtures thereof; (ii) amines such as aliphatic amines, ethylenediamine, diethylenetriamine, aminoethylpiperazine, triethylenetetramine, tris(2-aminoethyl)amine, N,N′-bis-(2aminoethyle)piperazine, piperazinoethylethylenediamine, and tetraethylenepentaamine, propyleneamine, aniline, substituted aniline, and combinations thereof; (iii) amides such as urea, 1-methyl urea, 1,1-dimethyl urea, 1,3-dimethylurea, thiourea, urea, benzamide, acetamide, and combinations thereof; (iv) carboxylic acids such as phenylpropionic acid, phenylacetic acid, benzoic acid, oxalic acid, malonic acid, adipic acid, succinic acid, citric acid, tricarballylic acid, and combinations thereof; or (v) alcohols such as aliphatic alcohols, phenol, substituted phenol, ethylene glycol, propylene glycol, resorcinol, substituted resorcinol, glycerol, benzene triol, and combinations thereof. In certain embodiments of the first and second embodiments, the eutectic composition comprises a cationic source and an anionic source that is a hydrogen bond donor compound selected from the group described above as (i). In certain embodiments of the first and second embodiments, the eutectic composition comprises a cationic source and an anionic source that is a hydrogen bond donor compound selected from the group described above as (ii). In certain embodiments of the first and second embodiments, the eutectic composition comprises a cationic source and an anionic source that is a hydrogen bond donor compound selected from the group described above as (iii). In certain embodiments of the first and second embodiments, the eutectic composition comprises a cationic source and an anionic source that is a hydrogen bond donor compound selected from the group described above as (iv).

In certain embodiments of the first and second embodiments, the eutectic composition comprises a cationic source and an anionic source that is a hydrogen bond donor compound selected from the group described above as (v).

In certain embodiments of the first and second embodiments, when the anionic source is an amine, useful amines can be described as having the formula V:

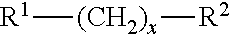

wherein R¹ and R² are —NH₂, NHR³, or —NR³R⁴, and x is an integer of at least 2. In one or more embodiments, x is from 2 to about 10 or from 2 to 10 (e.g., 2, 3, 4, 5, 6, 7, 8, 9, or 10), in other embodiments x is from about 2 to about 8 or from 2 to 8 (e.g., 2, 3, 4, 5, 6, 7, or 8), and in other embodiments x is from about 2 to about 6 or 2 to 6 (e.g., 2, 3, 4, 5, or 6).

In certain embodiments of the first and second embodiments, when the anionic source is an amide, useful amides can be described as having formula VI.

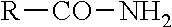

wherein R is H, NH₂, CH₃, or CF₃.

In certain embodiments of the first and second embodiments, when the anionic source is a carboxylic acid, useful carboxylic acids include mono-functional, di-functional, and tri-functional organic acids. Such organic acids may include alkyl acids, aryl acids, and mixed alkyl-aryl acids.

In certain embodiments of the first and second embodiments, when the anionic source is an alcohol, useful alcohols include, but are not limited to, monools, diols, and triols. Specific examples of monools include aliphatic alcohols, phenol, substituted phenol, and mixtures thereof. Specific examples of diols include ethylene glycol, propylene glycol, resorcinol, substituted resorcinol, and mixtures thereof. Specific examples of triols include, but are not limited to, glycerol, benzene triol, and mixtures thereof.

In certain embodiments of the first and second embodiments, the eutectic composition includes an anionic source that is selected from metal halides, preferably from the group consisting of aluminum chloride, aluminum bromide, aluminum iodide, zinc chloride, zinc bromide, zinc iodide, tin chloride, tin bromide, tin iodide, iron chloride, iron bromide, iron iodide, and combinations thereof.

In certain embodiments of the first and second embodiments, the eutectic composition includes an anionic source that is selected from metal halide hydrate compounds. Generally, suitable metal halide hydrate compounds for use in certain embodiments of the first and second embodiments, include, corresponding metal halide hydrates to the metal halides discussed above, e.g., aluminum halides, zinc halides, tin halides, and iron halides. For example, non-limiting examples include aluminum chloride hexahydrate and copper chloride dihydrate which correspond to the halides mentioned above.

In preferred embodiments of the first and second embodiments, the eutectic composition comprises (includes) a combination of an ammonium compound selected from (ii) above and a hydrogen bond donor compound selected from (iii) above. In particularly preferred embodiments of the first and second embodiments, the eutectic composition comprises a combination of choline chloride and urea. In certain such embodiments, the amount of eutectic composition is preferably 0.01 to 2 phr or 0.01 to 2 phr (e.g., 0.01, 0.05, 0.1, 0.5, 1, 1.5, or 2 phr), more preferably about 0.1 to about 1 phr (e.g., 0.1, 0.2, 0.3, 0.4, 0.5, 0.6, 0.7, 0.8, 0.9 or 1 phr).

In certain embodiments of the first and second embodiments, the eutectic composition is prepared prior to introducing the eutectic composition to the other ingredients of the rubber composition. In other words, according to such embodiments, a first constituent is pre-combined with a second constituent prior to introducing the mixture thereof (as the eutectic composition) to the vulcanizable composition. In one or more embodiments of the first and second embodiments, the combined constituents are mixed until a homogeneous liquid composition is observed which can be considered to constitute the eutectic composition.

In certain embodiments of the first and second embodiments, the eutectic composition is pre-combined with one or more ingredients of the rubber formulation prior to introducing the eutectic mixture to the vulcanizable composition. In other words, in one or more embodiment of the first and second embodiments, a constituent of the vulcanizable composition (e.g., a metal compound such as zinc oxide) is combined with the eutectic composition to form a pre-combination or masterbatch prior to introducing the pre-combination to the mixer in which the rubber is mixed. For example, zinc oxide may be dissolved in the eutectic solvent prior to introduction to the rubber within the mixer. In preferred embodiments of the first and second embodiments, the eutectic composition is the minor component of the pre-combination, and therefore the constituent that is pre-mixed with the eutectic composition can be considered a carrier for the eutectic composition. For example, the eutectic composition can be combined with a larger volume of zinc oxide, and the zinc oxide will act as a carrier for delivery the combination of zinc oxide and eutectic composition as a solid to the rubber within the mixer. In yet other embodiments, one of the members of the eutectic pair acts as a solid carrier for the eutectic composition, and therefore the combination of the first and second ingredients of the eutectic composition form a pre-combination that can be added as a solid to the rubber within the mixer. The skilled person will appreciate that mixtures of this nature can be formed by combining an excess of the first or second eutectic members is excess, relative to the other eutectic member, to maintain a solid composition at the desired temperature.

In one or more embodiments of the first and second embodiments, the eutectic solvent is introduced to the vulcanizable rubber as an initial ingredient in the formation of a rubber masterbatch. As a result, the eutectic solvent undergoes high shear, high temperature mixing with the rubber. In one or more embodiments of the first and second embodiments, the eutectic solvent undergoes mixing with the rubber at minimum temperatures in excess of 110° C., in other embodiments in excess of 130° C., and in other embodiments in excess of 150° C. In one or more embodiments of the first and second embodiments, high shear, high temperature mixing takes place at a temperature from about 110° C. to about 170° C.

In other embodiments of the first and second embodiments, the eutectic solvent is introduced to the vulcanizable rubber, either sequentially or simultaneously, with the sulfur-based curative. As a result, the eutectic solvent undergoes mixing with the vulcanizable rubber at a maximum temperature below 110° C., in other embodiments below 105° C., and in other embodiments below 100° C. In one or more embodiments of the first and second embodiments, mixing with the curative takes place at a temperature from about 70° C. to about 110° C.

As with the eutectic solvent, the zinc oxide and the stearic acid can be added as initial ingredients to the rubber masterbatch, and therefore these ingredients will undergo high temperature, high shear mixing. Alternatively, in preferred embodiments of the first and second embodiments, the zinc oxide and the stearic acid can be added along with the sulfur-based curative (e.g., in a final mixing stage) and thereby only undergo low-temperature mixing.

In certain embodiments of the first and second embodiments, zinc oxide is introduced to the rubber composition separately and individually from the eutectic solvent. In preferred embodiments of the first and second embodiments, the zinc oxide and the eutectic solvent are pre-combined to form a zinc oxide masterbatch, which may include a solution in which the zinc oxide is dissolved or otherwise dispersed in the eutectic solvent. The zinc oxide masterbatch can then be introduced to the vulcanizable rubber.

### Reinforcing Filler

As discussed above, according to the first and second embodiments disclosed herein, the rubber composition comprises (includes) about 30 to about 150 phr or 30 to 150 phr (e.g., 30, 40, 50, 60, 70, 80, 90, 100, 110, 120, 130, 140 or 150 phr) of reinforcing filler selected from carbon black, silica, and a combination thereof. By stating that the reinforcing filler is selected from carbon black, silica, and a combination thereof is meant to encompass embodiments where the only reinforcing filler is carbon black, embodiments where the only reinforcing filler is silica, and embodiments where the reinforcing filler includes both carbon black and silica. As discussed in more detail below, when both carbon black and silica are present, the relative amounts of each may vary. In certain embodiments of the first and second embodiments, the rubber composition comprises about 30 to about 60 phr or 30 to 60 phr (e.g., 30, 35, 40, 45, 50, 55, or 60 phr) of reinforcing filler selected from carbon black, silica, and a combination thereof. In certain other embodiments of the first and second embodiments, the rubber composition comprises about 50 to about 150 phr or 50 to 150 phr (e.g., 50, 55, 60, 65, 70, 75, 80, 85, 90, 95, 100, 105, 110, 115, 120, 125, 130, 135, 140, 145, or 150 phr) of reinforcing filler selected from carbon black, silica, and a combination thereof.

In those embodiments of the first and second embodiments where a carbon black filler is present as part (or all) of the reinforcing filler, one or more than one carbon black may be present. According to the first and second embodiments, the particular type or types of carbon black utilized may vary. Generally, suitable carbon blacks for use as a reinforcing filler in the rubber composition of certain embodiments of the first and second embodiments include any of the commonly available, commercially-produced carbon blacks, including those having a surface area of at least about 20 m²/g (including at least 20 m²/g) and, more preferably, at least about 35 m²/g up to about 200 m²/g or higher (including 35 m²/g up to 200 m²/g). Surface area values used herein for carbon blacks are determined by ASTM D-1765 using the cetyltrimethyl-ammonium bromide (CTAB) technique. Among the useful carbon blacks are furnace black, channel blacks, and lamp blacks. More specifically, examples of useful carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which can be utilized include acetylene blacks.

In certain embodiments of the first and second embodiments, the rubber composition includes a mixture of two or more of the foregoing blacks. Preferably according to the first and second embodiments, if a carbon black filler is present it consists of only one type (or grade) of reinforcing carbon black. Typical suitable carbon blacks for use in certain embodiments of the first and second embodiments are N-110, N-220, N-339, N-330, N-351, N-550, and N-660, as designated by ASTM D-1765-82a. The carbon blacks utilized can be in pelletized form or an unpelletized flocculent mass. Preferably, for more uniform mixing, unpelletized carbon black is preferred.

In those embodiments of the first and second embodiments where a silica filler is present as part of the reinforcing filler, one or more than one silica may be present. Additionally, in those embodiments of the first and second embodiments where a silica filler is present, the surface area of the reinforcing silica filler may vary. According to the first and second embodiments, the particular type of silica for the at least one reinforcing silica filler may vary.

Non-limiting examples of reinforcing silica fillers suitable for use in certain embodiments of the first and second embodiments include, but are not limited to, precipitated amorphous silica, wet silica (hydrated silicic acid), dry silica (anhydrous silicic acid), fumed silica, calcium silicate and the like. Other suitable reinforcing silica fillers for use in certain embodiments of the first and second embodiments include, but are not limited to, aluminum silicate, magnesium silicate (Mg₂SiO₄, MgSiO₃ etc.), magnesium calcium silicate (CaMgSiO₄), calcium silicate (Ca₂SiO₄ etc.), aluminum silicate (Al₂SiO₈, Al₄·3SiO₄·5H₂O etc.), aluminum calcium silicate (Al₂O₃·CaO₂SiO₂, etc.), and the like. Among the listed reinforcing silica fillers, precipitated amorphous wet-process, hydrated silica fillers are preferred. Such reinforcing silica fillers are produced by a chemical reaction in water, from which they are precipitated as ultrafine, spherical particles, with primary particles strongly associated into aggregates, which in turn combine less strongly into agglomerates. The surface area, as measured by the BET method, is a preferred measurement for characterizing the reinforcing character of different reinforcing silica fillers. In certain embodiments of the first and second embodiments disclosed herein, the rubber composition comprises a reinforcing silica filler having a surface area (as measured by the BET method) of about 100 m²/g to about 400 m²/g, 100 m²/g to 400 m²/g (e.g., 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or 400 m²/g), about 100 m²/g to about 350 m²/g, or 100 m²/g to 350 m²/g (e.g., 100, 110, 120, 130, 140, 150, 160, 170, 180, 190, 200, 210, 220, 230, 240, 250, 260, 270, 280, 290, 300, 310, 320, 330, 340, or 350 m²/g). In certain embodiments of the first and second embodiments disclosed herein, the rubber composition comprises a reinforcing silica filler having a BET surface area of about 110 m²/g to about 200 m²/g, 110 m²/g to 200 m²/g (e.g., 110, 120, 130, 140, 150, 160, 170, 180, 190, or 200 m²/g), with the ranges of about 110 to about 140 m²/g, 110 to 140 m²/g (e.g., 110, 115, 120, 125, 130, 135, or 140 m²/g), 180 m²/g to about 200 m²/g and 180 m²/g to 200 m²/g (e.g., 180, 185, 190, 195, or 200 m²/g) being included; in certain such embodiments the only silica filler present in the rubber composition has a BET surface area within one of the foregoing ranges. In other embodiments of the first and second embodiments disclosed herein, the rubber composition comprises a reinforcing silica filler having a BET surface of about 210 m²/g to about 320 m²/g, 210 m²/g to 320 m²/g (e.g., 210, 215, 220, 225, 230, 235, 240, 245, 250, 255, 260, 265, 270, 275, 280, 285, 290, 295, 300, 305, 310, 315, or 320 m²/g), about 220 m²/g to about 300 m²/g and 220 m²/g to 300 m²/g (e.g., 220, 225, 230, 235, 240, 245, 250, 255, 260, 265, 270, 275, 280, 285, 290, 295, or 300 m²/g), being included; in certain such embodiments the only silica filler present in the rubber composition has a BET surface area within one of the foregoing ranges. In certain embodiments of the first and second embodiments disclosed herein, the rubber composition comprises reinforcing silica filler having a pH of about 5.5 to about 8, 5.5 to 8 (e.g., 5.5, 5.7, 5.9, 6.1, 6.3, 6.5, 6.7, 6.9, 7.1, 7.3, 7.5, 7.7, 7.9, or 8), about 6 to about 8, 6 to 8 (e.g., 6, 6.2, 6.4, 6.6, 6.8, 7, 7.2, 7.4, 7.6, 7.8, or 8), about 6 to about 7.5, 6 to 7.5, about 6.5 to about 8, 6.5 to 8, about 6.5 to about 7.5, 6.5 to 7.5, about 5.5 to about 6.8, or 5.5 to 6.8. Some of the commercially available reinforcing silica fillers which can be used in certain embodiments of the first and second embodiments include, but are not limited to, Hi-Sil® EZ120G, Hi-Sil® EZ120G-D, Hi-Sil®134G, Hi-Sil® EZ 160G, Hi-Sil® EZ 160G-D, Hi-Sil®190, Hi-Sil®190G-D, Hi-Sil® EZ 200G, Hi-Sil® EZ 200G-D, Hi-Sit® 210, Hi-Sil®233, Hi-Sil®243LD, Hi-Sil®255CG-D, Hi-Sil®315-D, Hi-Sil®315G-D, Hi-Sil® HDP 320G and the like, produced by PPG Industries (Pittsburgh, Pa.) As well, a number of useful commercial grades of different reinforcing silica fillers are also available from Evonik Corporation (e.g., Ultrasil®320 GR, Ultrasil® 5000 GR, Ultrasil®5500 GR, Ultrasil® 7000 GR, Ultrasil® VN2 GR, Ultrasil® VN2, Ultrasil® VN3, Ultrasil® VN3 GR, Ultrasil®7000 GR, Ultrasil® 7005, Ultrasil® 7500 GR, Ultrasil®7800 GR, Ultrasil® 9500 GR, Ultrasil® 9000 G, Ultrasil® 9100 GR), and Solvay (e.g., Zeosil® 1115MP, Zeosil®1085GR, Zeosil®1165MP, Zeosil®1200MP, Zeosil® Premium, Zeosil®195HR, Zeosil®195GR, Zeosil® 185GR, Zeosil®175GR, and Zeosil®165 GR).

### Silica Coupling Agent

In certain embodiments of the first and second embodiments disclosed herein when a silica filler is present, one or more than one silica coupling agent may also (optionally) be utilized. In preferred embodiments of the first and second embodiments, at least one silica coupling agent is utilized when a silica filler is present. Silica coupling agents are useful in preventing or reducing aggregation of the silica filler in rubber compositions. Aggregates of the silica filler particles are believed to increase the viscosity of a rubber composition, and, therefore, preventing this aggregation reduces the viscosity and improves the processability and blending of the rubber composition.

Generally, any conventional type of silica coupling agent can be used, such as those having a silane and a constituent component or moiety that can react with a polymer, particularly a vulcanizable polymer. The silica coupling agent acts as a connecting bridge between silica and the polymer. Suitable silica coupling agents for use in certain embodiments of the first and second embodiments disclosed herein include those containing groups such as alkyl alkoxy, mercapto, blocked mercapto, sulfide-containing (e.g., monosulfide-based alkoxy-containing, disulfide-based alkoxy-containing, tetrasulfide-based alkoxy-containing), amino, vinyl, epoxy, and combinations thereof. In certain embodiments, the silica coupling agent can be added to the rubber composition in the form of a pre-treated silica; a pre-treated silica has been pre-surface treated with a silane prior to being added to the rubber composition. The use of a pre-treated silica can allow for two ingredients (i.e., silica and a silica coupling agent) to be added in one ingredient, which generally tends to make rubber compounding easier.

Alkyl alkoxysilanes have the general formula R¹⁰ₚSi(OR¹¹)₄₋ₚ where each R¹¹ is independently a monovalent organic group, and p is an integer from 1 to 3, with the proviso that at least one R¹⁰ is an alkyl group. Preferably p is 1. Generally, each R¹⁰ independently comprises C₁ to C₂₀ aliphatic, C₅ to C₂₀ cycloaliphatic, or C₆ to C₂₀ aromatic; and each R¹¹ independently comprises C₁ to C₆ aliphatic. In certain exemplary embodiments, each R¹⁰ independently comprises C₆ to C₁₅ aliphatic and in additional embodiments each R¹⁰ independently comprises C₈ to C₁₄ aliphatic. Mercapto silanes have the general formula HS—R¹³—Si(R¹⁴)(R¹⁵)₂ where R¹³ is a divalent organic group, R¹⁴ is a halogen atom or an alkoxy group, each R¹⁵ is independently a halogen, an alkoxy group or a monovalent organic group. The halogen is chlorine, bromine, fluorine, or iodine. The alkoxy group preferably has 1-3 carbon atoms. Blocked mercapto silanes have the general formula B—S—R¹⁶—Si—X₃ with an available silyl group for reaction with silica in a silica-silane reaction and a blocking group B that replaces the mercapto hydrogen atom to block the reaction of the sulfur atom with the polymer. In the foregoing general formula, B is a block group which can be in the form of an unsaturated heteroatom or carbon bound directly to sulfur via a single bond; R¹⁶ is C₁ to C₆ linear or branched alkylidene and each X is independently selected from the group consisting of C₁ to C₄ alkyl or C₁ to C₄ alkoxy.

Non-limiting examples of alkyl alkoxysilanes suitable for use in certain embodiments of the first and second embodiments include, but are not limited to, octyltriethoxysilane, octyltrimethoxysilane, trimethylethoxysilane, cyclohexyltriethoxysilane, isobutyltriethoxy-silane, ethyltrimethoxysilane, cyclohexyl-tributoxysilane, dimethyldiethoxysilane, methyltriethoxysilane, propyltriethoxysilane, hexyltriethoxysilane, heptyltriethoxysilane, nonyltriethoxysilane, decyltriethoxysilane, dodecyltriethoxysilane, tetradecyltriethoxysilane, octadecyltriethoxysilane, methyloctyldiethoxysilane, dimethyldimethoxysilane, methyltrimethoxysilane, propyltrimethoxysilane, hexyltrimethoxysilane, heptyltrimethoxysilane, nonyltrimethoxysilane, decyltrimethoxysilane, dodecyltrimethoxysilane, tetradecyltrimethoxysilane, octadecyl-trimethoxysilane, methyloctyl dimethoxysilane, and mixtures thereof.

Non-limiting examples of bis(trialkoxysilylorgano)polysulfides suitable for use in certain embodiments of the first and second embodiments include bis(trialkoxysilylorgano) disulfides and bis(trialkoxysilylorgano)tetrasulfides. Specific non-limiting examples of bis(trialkoxysilylorgano)disulfides include, but are not limited to, 3,3′-bis(triethoxysilylpropyl) disulfide, 3,3′-bis(trimethoxysilylpropyl)disulfide, 3,3′-bis(tributoxysilylpropyl)disulfide, 3,3′-bis(tri-t-butoxysilylpropyl)disulfide, 3,3′-bis(trihexoxysilylpropyl)disulfide, 2,2′-bis(dimethylmethoxysilylethyl)disulfide, 3,3′-bis(diphenylcyclohexoxysilylpropyl)disulfide, 3,3′-bis(ethyl-di-sec-butoxysilylpropyl)disulfide, 3,3′-bis(propyldiethoxysilylpropyl)disulfide, 12,12′-bis(triisopropoxysilylpropyl)disulfide, 3,3′-bis(dimethoxyphenylsilyl-2-methylpropyl)disulfide, and mixtures thereof. Non-limiting examples of bis(trialkoxysilylorgano)tetrasulfide silica coupling agents suitable for use in certain embodiments of the first and second embodiments include, but are not limited to, bis(3-triethoxysilylpropyl)tetrasulfide, bis(2-triethoxysilylethyl) tetrasufide, bis(3-trimethoxysilylpropyl)tetrasulfide, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropylbenzothiazole tetrasulfide, and mixtures thereof. Bis(3-triethoxysilylpropyl)tetrasulfide is sold commercially as Si69® by Evonik Degussa Corporation.

Non-limiting examples of mercapto silanes suitable for use in certain embodiments of the first and second embodiments disclosed herein include, but are not limited to, 1-mercaptomethyltriethoxysilane, 2-mercaptoethyltriethoxysilane, 3-mercaptopropyltriethoxysilane, 3-mercaptopropylmethyldiethoxysilane, 2-mercaptoethyltripropoxysilane, 18-mercaptooctadecyldiethoxychlorosilane, and mixtures thereof.

Non-limiting examples of blocked mercapto silanes suitable for use in certain embodiments of the first and second embodiments disclosed herein include, but are not limited to, those described in U.S. Pat. Nos. 6,127,468; 6,204,339; 6,528,673; 6,635,700; 6,649,684; and 6,683,135, the disclosures of which are hereby incorporated by reference. Representative examples of the blocked mercapto silanes include, but are not limited to, 2-triethoxysilyl-1-ethylthioacetate; 2-trimethoxysilyl-1-ethylthioacetate; 2-(methyldimethoxysilyl)-1-ethylthioacetate; 3-trimethoxysilyl-1-propylthioacetate; triethoxysilylmethyl-thioacetate; trimethoxysilylmethylthioacetate; triisopropoxysilylmethylthioacetate; methyldiethoxysilylmethylthioacetate; methyldimethoxysilylmethylthioacetate; methyldiisopropoxysilylmethylthioacetate; dimethylethoxysilylmethylthioacetate; dimethylmethoxysilylmethylthioacetate; dimethylisopropoxysilylmethylthioacetate; 2-triisopropoxysilyl-1-ethylthioacetate; 2-(methyldiethoxysilyl)-1-ethylthioacetate, 2-(methyldiisopropoxysilyl)-1-ethylthioacetate; 2-(dimethylethoxysilyl-1-ethylthioacetate; 2-(dimethylmethoxysilyl)-1-ethylthioacetate; 2-(dimethylisopropoxysilyl)-1-ethylthioacetate; 3-triethoxysilyl-1-propylthioacetate; 3-triisopropoxysilyl-1-propylthioacetate; 3-methyldiethoxysilyl-1-propyl-thioacetate; 3-methyldimethoxysilyl-1-propylthioacetate; 3-methyldiisopropoxysilyl-1-propylthioacetate; 1-(2-triethoxysilyl-1-ethyl)-4-thioacetylcyclohexane; 1-(2-triethoxysilyl-1-ethyl)-3-thioacetylcyclohexane; 2-triethoxysilyl-5-thioacetylnorbornene; 2-triethoxysilyl-4-thioacetylnorbornene; 2-(2-triethoxysilyl-1-ethyl)-5-thioacetylnorbornene; 2-(2-triethoxy-silyl-1-ethyl)-4-thioacetylnorbornene; 1-(1-oxo-2-thia-5-triethoxysilylphenyl)benzoic acid; 6-triethoxysilyl-1-hexylthioacetate; 1-triethoxysilyl-5-hexylthioacetate; 8-triethoxysilyl-1-octylthioacetate; 1-triethoxysilyl-7-octylthioacetate; 6-triethoxysilyl-1-hexylthioacetate; 1-triethoxysilyl-5-octylthioacetate; 8-trimethoxysilyl-1-octylthioacetate; 1-trimethoxysilyl-7-octylthioacetate; 10-triethoxysilyl-1-decylthioacetate; 1-triethoxysilyl-9-decylthioacetate; 1-triethoxysilyl-2-butylthioacetate; 1-triethoxysilyl-3-butylthioacetate; 1-triethoxysilyl-3-methyl-2-butylthioacetate; 1-triethoxysilyl-3-methyl-3-butylthioacetate; 3-trimethoxysilyl-1-propylthiooctanoate; 3-triethoxysilyl-1-propyl-1-propylthiopalmitate; 3-triethoxysilyl-1-propylthiooctanoate; 3-triethoxysilyl-1-propylthiobenzoate; 3-triethoxysilyl-1-propylthio-2-ethylhexanoate; 3-methyldiacetoxysilyl-1-propylthioacetate; 3-triacetoxysilyl-1-propylthioacetate; 2-methyldiacetoxysilyl-1-ethylthioacetate; 2-triacetoxysilyl-1-ethylthioacetate; 1-methyldiacetoxysilyl-1-ethylthioacetate; 1-triacetoxysilyl-1-ethyl-thioacetate; tris-(3-triethoxysilyl-1-propyl)trithiophosphate; bis-(3-triethoxysilyl-1-propyl)methyldithiophosphonate; bis-(3-triethoxysilyl-1-propyl)ethyldithiophosphonate; 3-triethoxysilyl-1-propyldimethylthiophosphinate; 3-triethoxysilyl-1-propyldiethylthiophosphinate; tris-(3-triethoxysilyl-1-propyl)tetrathiophosphate; bis-(3-triethoxysilyl-1 propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyldimethoxysilyl-1-propyl)methyldithiophosphonate; bis-(3-methyldimethoxysilyl-1-propyl)-ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethylthiosulfate; 3-triethoxysilyl-1-propylmethanethiosulfonate; 3-triethoxysilyl-1-propylethanethiosulfonate; 3-triethoxysilyl-1-propylbenzenethiosulfonate; 3-triethoxysilyl-1-propyltoluenethiosulfonate; 3-triethoxysilyl-1-propylnaphthalenethiosulfonate; 3-triethoxysilyl-1-propylxylenethiosulfonate; triethoxysilylmethylmethylthiosulfate; triethoxysilylmethylmethanethiosulfonate; triethoxysilylmethylethanethiosulfonate; triethoxysilylmethylbenzenethiosulfonate; triethoxysilylmethyltoluenethiosulfonate; triethoxysilylmethylnaphthalenethiosulfonate; triethoxysilylmethylxylenethiosulfonate, and the like. Mixtures of various blocked mercapto silanes can be used. A further example of a suitable blocked mercapto silane for use in certain exemplary embodiments is NXT™ silane (3-octanoylthio-1-propyltriethoxysilane), commercially available from Momentive Performance Materials Inc. of Albany, NY.

Non-limiting examples of pre-treated silicas (i.e., silicas that have been pre-surface treated with a silane) suitable for use in certain embodiments of the first and second embodiments disclosed herein include, but are not limited to, Ciptane® 255 LD and Ciptane® LP (PPG Industries) silicas that have been pre-treated with a mercaptosilane, and Coupsil® 8113 (Degussa) that is the product of the reaction between organosilane bis(triethoxysilylpropyl) polysulfide (Si69) and Ultrasil® VN3 silica. Coupsil 6508, Agilon 400™ silica from PPG Industries, Agilon 454® silica from PPG Industries, and 458® silica from PPG Industries. In those embodiments where the silica comprises a pre-treated silica, the pre-treated silica is used in an amount as previously disclosed for the silica filler (i.e., 81-120 phr or about 90 to about 120 phr, etc.).

When a silica coupling agent is utilized in an embodiment of the first and second embodiments, the amount used may vary. In certain embodiments of the first and second embodiments, the rubber compositions do not contain any silica coupling agent. In other preferred embodiments of the first and second embodiments, the silica coupling agent is present in an amount sufficient to provide a ratio of the total amount of silica coupling agent to silica filler of about 0.1:100 to about 1:5 (i.e., about 0.1 to about 20 parts by weight per 100 parts of silica), including 0.1:100 to 1:5, about 1:100 to about 1:10, 1:100 to 1:10, about 1:100 to about 1:20, 1:100 to 1:20, about 1:100 to about 1:25, and 1:100 to 1:25 as well as about 1:100 to about 0:100 and 1:100 to 0:100. In preferred embodiments of the first and second embodiments, the ratio of the total amount of silica coupling agent to silica filler falls within a ratio of 1:10 to 1:20 (i.e., 10 to 5 parts by weight per 100 parts of silica). In certain embodiments according to the first and second embodiments, the rubber composition comprises about 0.1 to about 15 phr silica coupling agent, including 0.1 to 15 phr (e.g., 0.1, 0.5, 1, 2, 3, 4, 5, 6, 7, 8, 9, 10, 11, 12, 13, 14, or 15 phr), about 0.1 to about 12 phr, 0.1 to 12 phr, about 0.1 to about 10 phr, 0.1 to 10 phr, about 0.1 to about 7 phr, 0.1 to 7 phr, about 0.1 to about 5 phr, 0.1 to 5 phr, about 0.1 to about 3 phr, 0.1 to 3 phr, about 1 to about 15 phr, 1 to 15 phr (e.g., 1, 2, 3, 4, 5, 6, 7, 8, 9, 10, 11, 12, 13, 14, or 15 phr), about 1 to about 12 phr, 1 to 12 phr (e.g., 1, 2, 3, 4, 5, 6, 7, 8, 9, 10, 11, or 12 phr), about 1 to about 10 phr, 1 to 10 phr (e.g., 1, 1.5, 2, 2.5, 3, 3.5, 4, 4.5, 5, 5.5, 6, 6.5, 7, 7.5, 8, 8.5, 9, 9.5, or 10 phr), about 1 to about 7 phr, 1 to 7 phr, about 1 to about 5 phr, 1 to 5 phr, about 1 to about 3 phr, 1 to 3 phr, about 3 to about 15 phr, 3 to 15 phr, about 3 to about 12 phr, 3 to 12 phr, about 3 to about 10 phr, 3 to 10 phr, about 3 to about 7 phr, 3 to 7 phr, about 3 to about 5 phr, 3 to 5 phr, about 5 to about 15 phr, 5 to 15 phr, about 5 to about 12 phr, 5 to 12 phr, about 5 to about 10 phr, 5 to 10 phr, about 5 to about 7 phr, or 5 to 7 phr. In preferred embodiments of the first and second embodiments, the rubber composition comprises silica coupling agent in an amount of 8 to 12 phr or one of the foregoing ranges falling within this range.

### Cure Package

As discussed above, according to the first and second embodiments disclosed herein, the rubber composition includes a cure package which comprises (includes) a sulfur-based vulcanizing agent, at least one vulcanization accelerator, a vulcanization activator, and a eutectic composition (discussed in detail below). Since the eutectic composition will generally be added during a final mixing stage (along with the sulfur-based vulcanizing agent and the at least one vulcanization accelerator), it is included in the description of the cure package.

According to the first and second embodiments disclosed herein, the cure package of the rubber composition includes a sulfur-based vulcanizing agent. The particular sulfur-based vulcanizing agent used may vary. In preferred embodiments of the first and second embodiments, the vulcanizing agent consists of (only) a sulfur-based curative. Examples of specific suitable sulfur vulcanizing agents include “rubbermaker's” soluble sulfur; sulfur donating curing agents, such as an amine disulfide, polymeric polysulfide, or sulfur olefin adducts; and insoluble polymeric sulfur. Preferably, the sulfur-based vulcanizing agent is soluble sulfur or a mixture of soluble and insoluble polymeric sulfur. For a general disclosure of suitable vulcanizing agents and other components used in curing, e.g., vulcanizing inhibitor and anti-scorching agents, one can refer to Kirk-Othmer, Encyclopedia of Chemical Technology, 3rd ed., Wiley Interscience, N.Y. 1982, Vol. 20, pp. 365 to 468, particularly Vulcanization Agents and Auxiliary Materials, pp. 390 to 402, or Vulcanization by A. Y. Coran, Encyclopedia of Polymer Science and Engineering, Second Edition (1989 John Wiley & Sons, Inc.), both of which are incorporated herein by reference. Sulfur-based vulcanizing agents can be used alone or in combination. Generally, the sulfur-based vulcanizing agents may be used in certain embodiments of the first and second embodiments in an amount ranging from 0.1 to 10 phr (e.g., 0.1, 0.5, 1, 2, 3, 4, 5, 6, 7, 8, 9, or 10 phr), including from 1 to 7.5 phr, including from 1 to 5 phr, and preferably from 1 to 3.5 phr (e.g., 1, 1.5, 2, 2.5, 3, or 3.5 phr).

According to the first and second embodiments, the rubber composition includes at least one vulcanization accelerator. Vulcanizing accelerators are used to control the time and/or temperature required for vulcanization and to improve properties of the vulcanizate. Examples of suitable vulcanizing accelerators for use in certain embodiments of the first and second embodiments disclosed herein include, but are not limited to, thiazole vulcanization accelerators, such as 2-mercaptobenzothiazole, 2,2′-dithiobis(benzothiazole) (MBTS), N-cyclohexyl-2-benzothiazole-sulfenamide (CBS), N-tert-butyl-2-benzothiazole-sulfenamide (TBBS), and the like; guanidine vulcanization accelerators, such as diphenyl guanidine (DPG) and the like; thiuram vulcanizing accelerators; carbamate vulcanizing accelerators; and the like. Generally, the amount of the vulcanization accelerator used ranges from 0.1 to 10 phr (e.g., 0.1, 0.5, 1, 2, 3, 4, 5, 6, 7, 8, 9, or 10 phr), preferably 1 to 6 phr (e.g., 1, 1.5, 2, 2.5, 3, 3.5, 4, 4.5, 5, 5.5 or 6 phr). Preferably, any vulcanization accelerator used in the rubber compositions of the first and second embodiments excludes any thiurams such as thiuram monosulfides and thiuram polysulfides (examples of which include TMTM (tetramethyl thiuram monosulfide), TMTD (tetramethyl thiuram disulfide), DPTT (dipentamethylene thiuram tetrasulfide), TETD (tetraethyl thiuram disulfide), TiBTD (tetraisobutyl thiuram disulfide), and TBzTD (tetrabenzyl thiuram disulfide)); in other words, the rubber compositions of the first and second embodiments preferably contain no thiuram accelerators (i.e., 0 phr).

As mentioned above, according to the first and second embodiments, the rubber composition includes a vulcanization activator. Vulcanizing or vulcanization activators are additives used to support vulcanization. Generally vulcanizing activators include both an inorganic and organic component. Zinc oxide is the most widely used inorganic vulcanization activator. Various organic vulcanization activators are commonly used including stearic acid, palmitic acid, lauric acid, and zinc salts of each of the foregoing. Generally, in certain embodiments of the first and second embodiments the amount of vulcanization activator used ranges from 0.1 to 6 phr (e.g., 0.1, 0.5, 1, 1.5, 2, 2.5, 3, 3.5, 4, 4.5, 5, 5.5, or 6 phr), preferably 0.5 to 4 phr (e.g., 0.5, 1, 1.5, 2, 2.5, 3 3.5, or 4 phr). In certain embodiments of the first and second embodiments, both zinc oxide and stearic acid are used as vulcanizing activators with the total amount utilized falling within one of the foregoing ranges; in certain such embodiments, the only vulcanizing activators used are zinc oxide and stearic acid.

In certain embodiments of the first and second embodiments, the cure package of the rubber composition also includes (further comprises) a vulcanization inhibitor. Vulcanization inhibitors are used to control the vulcanization process and generally retard or inhibit vulcanization until the desired time and/or temperature is reached. Common vulcanization inhibitors include, but are not limited to, PVI (cyclohexylthiophthalmide) from Santogard. Generally, in certain embodiments of the first and second embodiments the amount of vulcanization inhibitor is 0.01 to 1 phr (e.g., 0.01, 0.015, 0.02, 0.025, 0.03, 0.04, 0.05, 0.06, 0.07, 0.08, 0.09, 0.1, 0.2, 0.3, 0.4, 0.5, 0.6, 0.7, 0.8, 0.9, or 1 phr), preferably 0.01 to 0.3 phr (e.g., 0.01, 0.015, 0.02, 0.025, or 0.3 phr).

### Plasticizing Component

In certain embodiments of the first and second embodiments, the rubber composition also includes (further comprises) a plasticizing component. When present, the plasticizing component may comprise one or more ingredients selected from plasticizing oils and resins, According to the first and second embodiments, when the rubber composition includes a plasticizing component it comprises 0-50 phr (e.g., 0, 5, 10, 15, 20, 25, 30, 35, 40, 45, or 50 phr) of at least one plasticizing oil and 0-60 phr (e.g., 0, 5, 10, 15, 20, 25, 30, 35, 40, 45, 50, 55, or 60 phr) of at least one hydrocarbon resin having a Tg of at least 30° C. In other words, such rubber composition may include plasticizing oil, hydrocarbon resin, or a combination thereof. In preferred embodiments of the first and second embodiments at least one of the plasticizing oil or hydrocarbon resin is present in the rubber composition. In certain embodiments of the first and second embodiments, the plasticizing component includes 0-30 phr of plasticizing oil (e.g., 0, 5, 10, 15, 20, 25, or 30 phr) and 5-60 phr (e.g., 5, 10, 15, 20, 25, 30, 35, 40, 45, 50, 55 or 60 phr) of hydrocarbon resin, more preferably 0-15 phr of plasticizing oil and 5-50 phr of hydrocarbon resin. In certain embodiments of the third embodiment, plasticizing oil is present in an amount of at least 1 phr (e.g., 1-50 phr, 1-30 phr, 1-15 phr, 1-10 phr, 1-5 phr, etc.).

According to the first and second embodiments, when a plasticizing oil is present in the rubber composition, various types of plasticizing oils may be utilized, including, but not limited to aromatic, naphthenic, low PCA oils, and ester plasticizers. Preferably, the plasticizing oil is a liquid (pourable) at 25° C. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom. Suitable low PCA oils include mild extraction solvates (MES), treated distillate aromatic extracts (TDAE), TRAE, and heavy naphthenics. Suitable MES oils are available commercially as CATENEX SNR from SHELL, PROREX 15, and FLEXON 683 from EXXONMOBIL, VIVATEC 200 from BP, PLAXOLENE MS from TOTAL FINA ELF, TUDALEN 4160/4225 from DAHLEKE, MES-H from REPSOL, MES from Z8, and OLIO MES S201 from AGIP. Suitable TDAE oils are available as TYREX 20 from EXXONMOBIL, VIVATEC 500, VIVATEC 180, and ENERTHENE 1849 from BP, and EXTENSOIL 1996 from REPSOL. Suitable heavy naphthenic oils are available as SHELLFLEX 794, ERGON BLACK OIL, ERGON H2000, CROSS C2000, CROSS C2400, and SAN JOAQUIN 2000L. Suitable low PCA oils also include various plant-sourced oils such as can be harvested from vegetables, nuts, and seeds. Non-limiting examples include, but are not limited to, soy or soybean oil, sunflower oil (including high oleic sunflower oil having an oleic acid content of at least 60%, at least 70% or at least 80%), safflower oil, corn oil, linseed oil, cotton seed oil, rapeseed oil, cashew oil, sesame oil, Camellia oil, jojoba oil, macadamia nut oil, coconut oil, and palm oil. In certain embodiments of the first and second embodiment, the rubber composition includes only a limited amount of oil such as less than 10 phr (e.g., 9, 8, 7, 6, 5, 4, 3, 2, 1, or 0 phr), less than 5 phr, 1-5 phr, or even 0 phr.

As mentioned above, in certain embodiments of the first and second embodiments, the plasticizing component includes a plasticizing oil in the form of an ester plasticizer, which is a type of plasticizer that is generally liquid at room temperature. Although not strictly considered to be an oil, ester plasticizers are discussed herein along with plasticizing oils since they may serve a similar plasticizing purpose in the rubber compositions of the first and second embodiments. Suitable ester plasticizers are known to those of skill in the art and include, but are not limited to, phosphate esters, phthalate esters, adipate esters and oleate esters (i.e., derived from oleic acid). Taking into account that an ester is a chemical compound derived from an acid wherein at least one —OH is replaced with an —O-alkyl group, various alkyl groups may be used in suitable ester plasticizers for use in the tread rubber compositions, including generally linear or branched alkyl of C1 to C20 (e.g., C1, C2, C3, C4, C5, C6, C7, C8, C9, C10, C11, C12, C13, C14, C15, C16, C17, C18, C19, C20), or C6 to C12. Certain of the foregoing esters are based upon acids which have more than one —OH group and, thus, can accommodate one or more than one O-alkyl group (e.g., trialkyl phosphates, dialkyl phthalates, dialkyl adipates). Non-limiting examples of suitable ester plasticizers include trioctyl phosphate, dioctyl phthalate, dioctyl adipate, nonyl oleate, octyl oleate, and combinations thereof. The use of an ester plasticizer such as one or more of the foregoing may be beneficial to the snow or ice performance of a tire made from a tread rubber composition containing such ester plasticizer at least in part due to the relatively low Tg of ester plasticizers. In certain embodiments of the first and second embodiments, the rubber composition includes one or more ester plasticizers having a Tg of −40° C. to −70° C. (e.g., −40, −45, −50, −55, −60, −65, or −70° C.), or −50° C. to −65° C. (e.g., −50, −51, −52, −53, −54, −55, −56, −57, −58, −59, −60, −61, −62, −63, −64, or −65° C.). In those embodiments of the first and second embodiments wherein one or more ester plasticizers is utilized the amount utilized may vary. In certain embodiments of the first and second embodiments, one or more ester plasticizers are utilized in a total amount of 1-25 phr (e.g., 1, 2, 3, 4, 5, 6, 7, 8, 9, 10, 11, 12, 13, 14, 15, 16, 17, 18, 19, 20, 21, 22, 23, 24, or 25 phr), 1-20 phr (e.g., 1, 2, 3, 4, 5, 6, 7, 8, 9, 10, 11, 12, 13, 14, 15, 16, 17, 18, 19, or 20 phr), 1-15 phr (e.g., 1, 2, 3, 4, 5, 6, 7, 8, 9, 10, 11, 12, 13, 14, or 15 phr), 1-10, phr (e.g., 1, 2, 3, 4, 5, 6, 7, 8, 9, or 10 phr), 2-6 phr (e.g., 2, 3, 4, 5, or 6 phr) or 2-5 phr (e.g., 2, 3, 4, or 5 phr). In certain preferred embodiments of the first and second embodiments, the amount of any ester plasticizer is no more than 15 phr or no more than 12 phr. In certain embodiments of the first and second embodiments, one or more ester plasticizers are used (in one of the foregoing amounts) in combination with oil where the oil is present in an amount of 1 to less than 10 phr, or 1-5 phr. In other embodiments of the first and second embodiments, one or more ester plasticizers is used (in one of the foregoing amounts) without any oil being present in the tread rubber composition (i.e., 0 phr of oil).

When a hydrocarbon resin is used in the rubber compositions of the first and second embodiments, the particular type of hydrocarbon resin utilized in the plasticizing component may vary, and in particular may include plasticizing resins. As used herein, the term plasticizing resin refers to a compound that is solid at room temperature (23° C.) and is miscible in the rubber composition at the amount used which is usually at least 5 phr. Generally, the plasticizing resin will act as a diluting agent and can be contrasted with tackifying resins which are generally immiscible and may migrate to the surface of a rubber composition providing tack. In certain embodiments of the first and second embodiments, wherein a plasticizing resin is utilized, it comprises a hydrocarbon resin and may be aliphatic type, aromatic type or aliphatic/aromatic type depending on the monomers contained therein. Examples of suitable plasticizing resins for use in the rubber compositions of the third embodiment include, but are not limited to, cyclopentadiene (often abbreviated to CPD) or dicyclopentadiene (often abbreviated to DCPD) homopolymer or copolymer resins; terpene homopolymer or copolymer resins; phenol homopolymer or copolymer resins; C₅ or C₉ fraction homopolymer or copolymer resins; alpha-methylstyrene homopolymer or copolymer resins, and combinations thereof. Such resins may be used, for example, individually or in combination. In certain embodiments of the third embodiment, a plasticizing resin is used which meets at least one of the following: a Tg greater than 30° C. (preferably greater than 40° C. and/or no more than 120° C. or no more than 100° C.), a number average molecular weight (Mn) of between 400 and 2000 grams/mole (preferably 500-2000 grams/mole), and a polydispersity index (PI) of less than 3 (preferably less than 2), wherein PI=Mvv/Mn and Mvv is the weight-average molecular weight of the resin. Tg of the resin can be measured by DSC (Differential Scanning Calorimetry) according to ASTM D3418 (1999). Mw, Mn and PI of the resin may be determined by size exclusion chromatography (SEC), using THF, 35° C.; concentration 1 g/1; flow rate 1 milliliters/min; solution filtered through a filter with a porosity of 0.45 μm before injection; Moore calibration with polystyrene standards; set of 3 “Waters” columns in series (“Styragel” HR4E, HR1 and HR0.5); detection by differential refractometer (“Waters 2410”) and its associated operating software (“Waters Empower”).

### Other Ingredients

Various other ingredients that may optionally be added to the rubber compositions of the first and second embodiments as disclosed herein include waxes (which in some instances are antioxidants), processing aids, reinforcing resins, peptizers, and antioxidants/antidegradant. Ingredients which are antidegradants may also be classified as an antiozonant or antioxidant, such as those selected from: N,N′disubstituted-p-phenylenediamines, such as N-1,3-dimethylbutyl-N′phenyl-p-phenylenediamine (6PPD), N,N′-Bis(1,4-dimethylpently)-p-phenylenediamine (77PD), N-phenyl-N-isopropyl-p-phenylenediamine (IPPD), and N-phenyl-N′-(1,3-dimethylbutyl)-p-phenylenediamine (HPPD). Other examples of antidegradants include, acetone diphenylamine condensation product, 2,4-Trimethyl-1,2-dihydroquinoline, Octylated Diphenylamine, 2,6-di-t-butyl-4-methyl phenol and certain waxes. In certain other embodiments of the first and second embodiments, the tire tread rubber composition may be free or essentially free of antidegradants such as antioxidants or antiozonants.

### Properties Of The Rubber Composition

In certain embodiments of the first and second embodiments, the rubber composition can be described as having improved properties as compared to a comparative rubber composition where the guayule rubber is replaced with Hevea natural rubber (preferably a TSR grade which is viscosity stabilized). In certain such embodiments, the cured rubber composition (when cured at 145° C. for 33 minutes) has at least one of the following physical properties: (a) an elongation at break at 23° C. that is higher, preferably at least 3% higher (e.g., 3% higher, 4%, higher, 5% higher, 6% higher, 7% higher, 8% higher, or more), than a comparative cured rubber composition substituting Hevea natural rubber for the guayule natural rubber; (b) a tensile strength (Tb) at 23° C. that is higher, preferably at least 5% higher (e.g., 5% higher, 6% higher, 7% higher, 8% higher, 9% higher, 10% higher, or more), than a comparative cured rubber composition substituting Hevea natural rubber for the guayule natural rubber; or (c) a rolling resistance, as evidenced by tan delta at 60° C. that is lower, preferably at least 3% lower (e.g., 3% lower, 4% lower, 5% lower, 6% lower, 7% lower, or less), than a comparative cured rubber composition substituting Hevea natural rubber for the guayule natural rubber. In certain embodiments of the foregoing embodiments, the cured rubber composition has properties (a)-(d) and also has the following physical property (when cured at 145° C. for 33 minutes): (d) a modulus selected from M50, M100, M300, and combinations thereof, that is higher, preferably at least 2% higher (e.g., 2% higher, 3% higher, 4% higher, 5% higher, or more), than a comparative cured rubber composition substituting Hevea natural rubber for the guayule natural rubber. In certain embodiments of the first and second embodiments, each of (a)-(c) is met, preferably according to their preferred ranges. In other embodiments of the first and second embodiments, each of (a)-(d) is met, preferably according to their preferred ranges; in certain such embodiments the modulus is selected from M50 or M100, preferably M100.

As discussed in more detail below, in certain embodiments of the first and second embodiments, the tire component is for a TBR tire tread, preferably a road-contacting portion of a TBR tread. In certain such embodiments, the cured rubber composition of the TBR tread has at least one of the following physical properties (when cured at 145° C. for 33 minutes): (a) an elongation at break at 23° C. of at least about 250% or at least 250% (e.g., 250%, 275%, 300%, 325%, 350%, 375%, 400%, 425%, 450% 475%, 500%, 525%, 550%, 575%, or more), preferably about 250% to about 550% or 250% to 550% (e.g., 250%, 275%, 300%, 325%, 350%, 375%, 400%, 425%, 450%, 475%, 500%, 525% or 550%); (b) a tensile strength (Tb) at 23° C. of at least about 18 MPa or at least 18 MPa (e.g., 18 MPa, 20 MPa, 22 MPa, 24 MPa, 26 MPa, 28 MPa, 30 MPa, 32 MPa, 34 MPa, 35 MPa, 36 MPa, or more), preferably about 18 MPa to about 35 MPa or 18 MPa to 35 MPa (e.g., 18 MPa, 20 MPa, 22 MPa, 24 MPa, 26 MPa, 28 MPa, 30 MPa, 32 MPa, 34 MPa, or 35 MPa); or (c) a rolling resistance, as evidenced by tan delta at 60° C. of no more than about 0.21 or no more than 0.21 (e.g., 0.21, 0.2, 0.18, 0.16, 0.14, 0.12, 0.1, 0.08, 0.06, or less), preferably about 0.06 to about 0.21 or 0.06 to 0.21 (e.g., 0.21, 0.2, 0.18, 0.16, 0.14, 0.12, 0.1, 0.08, 0.06, or less). In certain embodiments of the foregoing embodiments, the cured rubber composition of the TBR tread has properties (a)-(d) and also has the following physical property (when cured at 145° C. for 33 minutes): (d) a modulus selected from at least one of the following: (i) a M50 of at least about 1.3 MPa or at least 1.3 MPa (e.g., 1.3 MPa, 1.5 MPa, 1.7 MPa, 1.8 MPa, 2 MPa, 2.2 MPa, 2.4 MPa, 2.5 MPa, 2.6 MPa, or more), preferably about 1.3 MPa to about 2.5 MPa or 1.3 MPa to 2.5 MPa (e.g., 1.3 MPa, 1.5 MPa, 1.7 MPa, 1.8 MPa, 2 MPa, 2.2 MPa, 2.4 MPa, or 2.5 MPa), (ii) a M100 of at least about 2.3 MPa or at least 2.3 MPa (e.g., 2.3 MPa, 2.5 MPa, 2.7 MPa, 2.9 MPa, 3 MPa, 3.2 MPa, 3.4 MPa, 3.5 MPa, 3.6 MPa, 3.8 MPa, 4 MPa, 4.2 MPa, 4.4 MPa, 4.5 MPa, 4.6 MPa, 4.8 MPa, 5 MPa, 5.2 MPa, or more), preferably about 2.3 MPa to about 5 MPa or 2.3 MPa to 5 MPa (e.g., 2.3 MPa, 2.5 MPa, 2.7 MPa, 2.9 MPa, 3 MPa, 3.2 MPa, 3.4 MPa, 3.5 MPa, 3.6 MPa, 3.8 MPa, 4 MPa, 4.2 MPa, 4.4 MPa, 4.5 MPa, 4.6 MPa, 4.8 MPa, or 5 MPa), or (iii) a M300 of at least about 12 MPa or at least 12 MPa (e.g., 12 MPa, 14 MPa, 15 MPa, 16 MPa, 18 MPa, 20 MPa, 22 MPa, 24 MPa, or more), preferably about 12 MPa to about 22 MPa or 12 MPa to 22 MPa (e.g., 12 MPa, 14 MPa, 15 MPa, 16 MPa, 18 MPa, 20 MPa, or 22 MPa).

### Tire Components

As discussed above, the first embodiment disclosed herein is directed to a method for providing a tire component and the second embodiment disclosed herein is directed to a tire component. According to the first and second embodiments, the particular tire component may vary. Exemplary tire components according to the first and second embodiments include, but are not limited to, tire tread, base tread, belt, and sidewall. In preferred embodiments of the first and second embodiments, the tire component is a tire tread, more preferably a road-contacting tread. In other embodiments of the first and second embodiments, the tire component is a sidewall of a tire. In yet other embodiments of the first and second embodiments, the tire component is a belt.

### Types of Tires

According to the first and second embodiments, the type of tire for which the tire component is designed may vary. According to the first and second embodiments, the tire component may be designed for a truck and bus radial tire (TBR tire) or for a passenger and light truck tire (PSR tire); in preferred embodiments of the foregoing, the tire component is either a TBR tread or a PSR tread, most preferably a road-contacting TBR tread or road-contacting PSR tread. As those of skill in the art will understanding, the particular amounts of total natural rubber, the amount (if any) of at least one conjugated diene monomer-based rubber (ii), and the amount of reinforcing filler may vary according to whether the tire component is for use in a TBR tire or a PSR tire. Generally, the amounts of total natural rubber, amount of replacement with guayule natural rubber, amount of at least one conjugated diene monomer-based rubber (ii), and amount of reinforcing filler for either a TBR tire component or a PSR tire component will fall within the ranges discussed above. However, the following sub-ranges of the foregoing may be particularly useful for either TBR or PSR tire components, including treads, as discussed in detail below.

In certain embodiments of the first and second embodiments, the type of tire for which the tire component is designed is a TBR tire. In preferred embodiments of the foregoing, the tire component is a tread, i.e., a tread for a TBR tire. In those embodiments of the first and second embodiments, wherein the tire component is a TBR tread, the rubber composition preferably includes about 30 to about 60 phr or 30 to 60 phr (e.g., 30, 35, 40, 45, 50, 55, or 60 phr) of reinforcing filler selected from carbon black, silica, and a combination thereof. In certain such embodiments of the first and second embodiments, the tread is for a first type of TBR tire and the reinforcing filler includes 0 to 20% by weight silica (e.g., 0%, 5%, 10%, 15%, or 20%) which can be considered to include 0% silica and up to 20% by weight silica as well as amounts within the foregoing such as 0 to 10% by weight silica (e.g., 0%, 5%, or 10%), 1 to 10% by weight silica (e.g., 1%, 5%, or 10%), 5 to 20% by weight silica (e.g., 5%, 10%, 15%, or 20%), 5 to 15% by weight silica (e.g., 5%, 10%, or 15%), and 10 to 20% by weight silica (e.g., 10%, 15%, or 20%) with the remainder of the reinforcing filler comprising carbon black. In other embodiments of the first and second embodiments, the tire component is a tread for a second type of TBR tire and preferably includes about 30 to about 60 phr of reinforcing filler, the reinforcing filler includes up to 60% by weight silica, including 0 to 60% by weight (e.g., 0%, 5%, 10%, 15%, 20%, 25%, 30%, 35%, 40%, 45%, 50%, 55% or 60%), 1-60% by weight (e.g., 1%, 5%, 10%, 15%, 20%, 25%, 30%, 35%, 40%, 45%, 50%, 55% or 60%), 5-50% by weight (e.g., 5%, 10%, 15%, 20%, 25%, 30%, 35%, 40%, 45%, or 50%), 10-60% by weight (e.g., 10%, 15%, 20%, 25%, 30%, 35%, 40%, 45%, 50%, 55% or 60%), 20-60% by weight (e.g., 20%, 25%, 30%, 35%, 40%, 45%, 50%, 55% or 60%), etc., with the remainder of the reinforcing filler comprising carbon black. In certain embodiments of the first and second embodiments wherein the tire component is a TBR tread, the rubber composition preferably includes 1 to 10 phr (e.g., 1, 2, 3, 4, 5, 6, 7, 8, 9, or 10 phr) of plasticizing component or an amount within the foregoing range such as 1 to 5 phr or 5 to 9 phr; in certain such embodiments, the plasticizing component includes 1-8 phr of resin (e.g., 1, 2, 3, 4, 5, 6, 7, or 8 phr) and 1-5 phr (e.g., 1, 2, 3, 4, or 5 phr) of plasticizing oil, with the total amount of plasticizing component being 1-10 phr.

In certain embodiments of the first and second embodiments, the type of tire for which the tire component is designed is a PSR tire. In preferred embodiments of the foregoing, the tire component is a tread, i.e., a tread for a PSR tire. In those embodiments of the first and second embodiments, wherein the tire component is a PSR tread, the rubber composition preferably includes about 50 to about 150 phr or 50 to 150 phr (e.g., 50, 55, 60, 65, 70, 75, 80, 85, 90, 95, 100, 105, 110, 115, 120, 125, 130, 135, 140, 145, or 150 phr) of reinforcing filler selected from carbon black, silica, and a combination thereof. The amount of 50 to 150 phr for reinforcing filler should be considered to include amounts within the foregoing such as 50 to 100 phr, 50 to 90 phr, 50 to 80 phr, 50 to 70 phr, 70 to 120 phr, 70 to 100 phr, 90 to 150 phr, 90 to 140 phr, 90 to 130 phr, 90 to 120 phr, etc. In certain embodiments of the first and second embodiments when the tire component is a PSR tread, the reinforcing filler is present in an amount of about 50 to about 150 phr or 50 to 150 phr, and silica comprises a majority by weight of the reinforcing filler (e.g., 51%, 60%, 70%, 80%, 85%, 90%, 95% or more), including amounts within the foregoing such as 51-95%, 60-90%, 70-90%, etc.

### Preparing The Rubber Compositions

The particular steps involved in preparing the rubber compositions of the first and second embodiments disclosed herein are generally those of conventionally practiced methods comprising mixing the ingredients in at least one non-productive master-batch stage and a final productive mixing stage. In certain embodiments of the first and second embodiments, the rubber composition is prepared by combining the ingredients for the rubber composition (as disclosed above) by methods known in the art, such as, for example, by kneading the ingredients together in a Banbury mixer or on a milled roll. Such methods generally include at least one non-productive master-batch mixing stage and a final productive mixing stage. The term non-productive master-batch stage is known to those of skill in the art and generally understood to be a mixing stage (or stages) where no vulcanizing agents or vulcanization accelerators are added. The term final productive mixing stage is also known to those of skill in the art and generally understood to be the mixing stage where the vulcanizing agents and vulcanization accelerators are added into the rubber composition. In certain embodiments of the first and second embodiments, the rubber composition is prepared by a process comprising more than one non-productive master-batch mixing stage.

In certain preferred embodiments of the first and second embodiments, the rubber composition is prepared by a process wherein the master-batch mixing stage includes at least one of tandem mixing or intermeshing mixing. Tandem mixing can be understood as including the use of a mixer with two mixing chambers with each chamber having a set of mixing rotors; generally, the two mixing chambers are stacked together with the upper mixer being the primary mixer and the lower mixer accepting a batch from the upper or primary mixer. In certain embodiments, the primary mixer utilizes intermeshing rotors and in other embodiments the primary mixer utilizes tangential rotors. Preferably, the lower mixer utilizes intermeshing rotors. Intermeshing mixing can be understood as including the use of a mixer with intermeshing rotors. Intermeshing rotors refers to a set of rotors where the major diameter of one rotor in a set interacts with the minor diameter of the opposing rotor in the set such that the rotors intermesh with each other. Intermeshing rotors must be driven at an even speed because of the interaction between the rotors. In contrast to intermeshing rotors, tangential rotors refers to a set of rotors where each rotor turns independently of the other in a cavity that may be referred to as a side. Generally, a mixer with tangential rotors will include a ram whereas a ram is not necessary in a mixer with intermeshing rotors.

Generally, the rubbers (or polymers) and at least one reinforcing filler (as well as any silane coupling agent, liquid plasticizers and resin) will be added in a non-productive or master-batch mixing stage or stages. Generally, at least the vulcanizing agent component and the vulcanizing accelerator component of a cure package will be added in a final or productive mixing stage.

In certain embodiments of the first and second embodiments, the rubber composition is prepared using a process wherein at least one non-productive master batch mixing stage is conducted at a temperature of about 130° C. to about 200° C. In certain embodiments of the first and second embodiments, the rubber composition is prepared using a final productive mixing stage conducted at a temperature below the vulcanization temperature in order to avoid unwanted pre-cure of the rubber composition. Therefore, the temperature of the productive or final mixing stage generally should not exceed about 120° C. and is typically about 40° C. to about 120° C., or about 60° C. to about 110° C. and, especially, about 75° C. to about 100° C. In certain embodiments of the first and second embodiments, the rubber composition is prepared according to a process that includes at least one non-productive mixing stage and at least one productive mixing stage. The use of silica fillers may optionally necessitate a separate re-mill stage for separate addition of a portion or all of such filler. This stage often is performed at temperatures similar to, although often slightly lower than, those employed in the masterbatch stage, i.e., ramping from about 90° C. to a drop temperature of about 150° C.

### Examples

The following examples illustrate specific and exemplary embodiments and/or features of the embodiments of the present disclosure. The examples are provided solely for the purposes of illustration and should not be construed as limitations of the present disclosure. Numerous variations over these specific examples are possible without departing from the spirit and scope of the presently disclosed embodiments. It should specifically be understood that rubber compositions according to the first and second embodiments disclosed herein can be made using different rubbers (according to the discussion above), using different combinations of and amounts of reinforcing filler, using different ingredients or amounts of plasticizing component (according to the discussion above), and using different particular cure package ingredients and amounts (according to the discussion above).

Examples A-H: Rubber compositions were prepared using the ingredients set forth in Table 1 below. As can be seen from a review of Table 1, the compositions utilized high cis-polybutadiene (abbreviated below as BR) and either Hevea natural rubber (a viscosity stabilizer TSR grade) which is abbreviated below as Hevea NR or guayule natural rubber which is abbreviated below as GR. The guayule natural rubber (GR) utilized had a Mw of 1.3 million grams/mole, a Mn of 0.35 million grams/mole, 2-5% by weight resin, and 0.1-0.2% by weight ash. The eutectic mixture used was a commercially available product purchased from Scionix Ltd. (and sold under the tradename Reline) which was a combination of choline chloride and urea. The rubber composition of Example G is considered to be inventive and the other rubber compositions (i.e., Examples A-F and H) are provided for purposes of comparison, as discussed in detail below. All ingredients in Table 1 are listed in phr and the mixing procedure used in preparing the rubber compositions was that provided in Table 2 (using a 6 pound Brabender mixer).

TABLE 1

| | A | B | C | D | E | F | G | H |
|---|---|---|---|---|---|---|---|---|
| Master batch | | | | | | | | |
| ingredients | | | | | | | | |
| Hevea NR | 80 | 80 | 0 | 0 | 0 | 80 | 0 | 0 |
| GR | 0 | 0 | 80 | 80 | 80 | 0 | 80 | 80 |
| BR | 20 | 20 | 20 | 20 | 20 | 20 | 20 | 20 |
| Carbon black | 50 | 50 | 50 | 50 | 50 | 50 | 50 | 50 |
| Silica | 0 | 7 | 0 | 7 | 7 | 0 | 0 | 0 |
| Stearic acid | 2 | 2 | 2 | 2 | 2 | 2 | 2 | 2 |
| 6PPD | 2 | 2 | 2 | 2 | 2 | 2 | 2 | 2 |
| Final mixing | | | | | | | | |
| ingredients | | | | | | | | |
| Sulfur | 1.2 | 1.2 | 1.2 | 1.2 | 1.38 | 1.2 | 1.2 | 1.38 |
| Zinc oxide | 2.5 | 2.5 | 2.5 | 2.5 | 2.5 | 2.5 | 2.5 | 2.5 |
| CBS¹ | 1.2 | 1.2 | 1.2 | 1.2 | 1.38 | 1.2 | 1.2 | 1.38 |
| Eutectic | 0 | 0 | 0 | 0 | 0 | 0.18 | 0.18 | 0 |
| mixture | | | | | | | | |

1 = N-cyclohexyl-2-benzothiazole-sulfenamide

TABLE 2
Mixing Parameters

| | | |
|---|---|---|
| Master-Batch | 30 seconds | Charge polymers |
| Stage (initial | | |
| temp: 100° C., | | |
| rotor rpm | | |
| started at 60) | | |
| | 30 to 300 | Charge any carbon black filler |
| | seconds | and other master-batch ingredients, |
| | | increase rotor speed to 60 rpm |
| | | Drop based on max temperature |
| | | of 155° C. or 5.0 minutes mixing |
| | | (whichever comes first) |
| Final Batch | 0 seconds | Charge master-batch |
| Stage (initial | | |
| temp: 65-70° C., | | |
| rotor rpm at 40) | | |
| | 0 seconds | Charge curatives and remaining |
| | | final ingredients |
| | | Drop based on max temperature |
| | | of 100° C. or 2.5 minutes mixing |
| | | (whichever comes first) |

For each of the rubber compositions A to H, as listed in Table 2, the properties listed in Table 3 were determined as follows.
Eb and Tb were measured following the guidelines of, but not restricted to, the standard procedure described in ASTM D-412, with dumbbell-shaped samples having a cross-section dimension of 4 mm in width and 1.9 mm in thickness at the center. During measurement, specimens were strained at a constant rate (20% per second) and the resulting force recorded as a function of extension (strain). Eb and Tb taken at 23° C. are sometimes referred to as room temperature measurements. Modulus measurements at 50%, 100% and 300% (in terms of MPa) are also referred to as M50, M100 and M300, respectively, and measure tensile stress of a sample of the rubber composition at 50%, 100% and 300% elongation, respectively. These modulus measurements are not a true modulus measurement and can be measured using the same method described for Eb and Tb.
Tan δ values were measured using a strain sweep test conducted with an Advanced Rheometric Expansion System (ARES) from TA Instruments. The test specimen had a cylindrical geometry having a length of 14.4 mm and a diameter of 7.8 mm. The test was conducted using a frequency of 10 Hz. The temperature was swept from −120° C. to 120° C. at a constant strain of 2%. Measurements at 0° C. and 60° C. were recorded for each of the rubber compositions. A rubber composition's tan δ at 60° C. is indicative of its rolling resistance when incorporated into a tire tread. A rubber composition's tan δ at 0° C. is indicative of its wet traction when incorporated into a tire tread, Generally, a lower tan δ value at 60° C. is considered to be an improvement and a higher tan δ at 0° C. is considered to be an improvement.

TABLE 3

| | A | B | C | D | E | F | G | H |
|---|---|---|---|---|---|---|---|---|
| Tb (MPa) | 18.98 | 17.68 | 18.07 | 16.63 | 18.91 | 18.77 | 20.41 | 17.21 |
| Eb (%) | 405 | 392 | 414 | 413 | 410 | 397 | 423 | 399 |
| tan δ | 0.213 | 0.234 | 0.215 | 0.223 | 0.215 | 0.212 | 0.205 | 0.212 |
| at 0° C. | | | | | | | | |
| tan δ | 0.17 | 0.185 | 0.17 | 0.176 | 0.171 | 0.172 | 0.163 | 0.173 |
| at 60° C. | | | | | | | | |
| M50 (MPa) | 1.23 | 1.28 | 1.1 | 1.1 | 1.14 | 1.27 | 1.26 | 1.29 |
| M100 (MPa) | 2.27 | 2.3 | 1.99 | 1.85 | 1.98 | 2.34 | 2.33 | 2.36 |
| M300 (MPa) | 11.56 | 11.37 | 10.18 | 9.19 | 9.73 | 11.8 | 11.37 | 11.94 |

As should be apparent from a review of the data provided in Table 3, the inventive rubber composition G exhibited the best (highest) Tb and best Eb (highest) of any of the rubber compositions. As well, the inventive rubber composition G exhibited the best (lowest) tan δ at 60° C. or rolling resistance of any of the rubber compositions. The effect of the addition of the eutectic composition is shown by comparing inventive rubber composition G to control rubber composition C (which differs from G only in that it lacks the eutectic composition), with rubber composition G exhibiting improved Tb, Eb, M50, M100, M300, and rolling resistance. Comparing inventive rubber composition G to control rubber composition F (which differs from G only in the substitution of Hevea natural rubber for the guayule rubber), reveals that rubber composition G has a Tb that is more than 5% higher (about 9% higher), a Eb that is more than 5% higher, and a rolling resistance that is improved/lower (about 3.3% lower). Comparing inventive rubber composition G to control rubber composition F also reveals that the M50 and M100 values for rubber composition G are almost as high as the corresponding values for F, differing by only 0.01 MPa. It was also considered noteworthy that the inventive rubber composition G exhibited improved Eb, Tb and rolling resistance as compared to rubber composition E which lacked any eutectic composition (as well as guayule rubber) but instead utilized an increased amount of vulcanizing accelerator (15% higher) and an increased amount of sulfur (15% higher) as compared to rubber composition G. (Generally, the effect of an increased amount of vulcanizing accelerator and sulfur can be observed in the comparative or control examples by comparing rubber compositions E and E.) Thus, it was determined that by the use of a eutectic composition, it is not necessary to increase the amounts of vulcanizing accelerator or sulfur to account for the resin content of the guayule rubber. As well, by using the eutectic composition (as in rubber composition G) rather than the increased amounts of vulcanizing accelerator and sulfur (composition E), the M50, M100 and M300 were all improved by more than 10%.

The following exemplary embodiments of the invention are specifically envisioned.

Embodiment 1: A method for providing a tire component, preferably a tire tread, the method comprising preparing a rubber composition comprising: (a) 100 parts of at least one rubber including (i) 10-100 parts of natural rubber, preferably 51-90 parts of natural rubber with at least 10% by weight provided by a guayule natural rubber having a Mw of at least 1.2 million grams/mole, preferably 1.25 to 1.35 grams/mole, an Mn of at least 0.25 million grams/mole, preferably 0.3 to 0.4 million grams/mole and a Mw/Mn of 3-4 million grams/mole and up to 90% by weight provided by a Hevea natural rubber, and (ii) 0-90 parts of at least one conjugated diene monomer-based rubber; (b) about 30 to about 150 phr of reinforcing filler selected from carbon black and silica, and (c) a cure package including a sulfur-based vulcanizing agent, at least one vulcanization accelerator, a vulcanization activator, and a eutectic composition, preferably in an amount of about 0.005 to about 3 phr, more preferably about 0.01 to about 1 phr, wherein (a), (b) and (c) are used in a cured rubber composition to provide the tire component.

Embodiment 2: The method of embodiment 1, wherein 51-90 parts of the natural rubber of (i) is provided by the guayule natural rubber.

Embodiment 3: The method of embodiment 1 or embodiment 2, wherein (ii) is present in an amount of 10-49 parts.

Embodiment 4: The method of any one of embodiments 1-3, wherein the eutectic composition is present in an amount of about 0.005 to about 3 phr.

Embodiment 5: The method of any one of embodiments 1-4, wherein the eutectic composition is present in an amount of about 0.01 to about 1 phr.

Embodiment 6: The method of any one of embodiments 1-5, wherein the guayule natural rubber provides at least 20% by weight of the natural rubber.

Embodiment 7: The method of any one of embodiments 1-5, wherein the guayule natural rubber provides at least 30% by weight of the natural rubber.

Embodiment 8: The method of any one of embodiments 1-5, wherein the guayule natural rubber provides at least 40% by weight of the natural rubber.

Embodiment 9: The method of any one of embodiments 1-5, wherein the guayule natural rubber provides a majority by weight of the natural rubber.

Embodiment 10: The method of any one of embodiments 1-5, wherein the guayule natural rubber provides at least 70% by weight of the natural rubber.

Embodiment 11: The method of any one of embodiments 1-5, wherein the guayule natural rubber, more preferably at least 80% by weight of the natural rubber.

Embodiment 12: The method of any one of embodiments 1-5, wherein the guayule natural rubber provides 100% by weight of the natural rubber.

Embodiment 13: The method of any one of embodiments 1-12, wherein the guayule natural rubber is functionalized, preferably with a carbon black-reactive functional group.

Embodiment 14: The method of any one of embodiments 1-13, wherein the guayule natural rubber has a resin content of about 2 to about 5% by weight and an ash content of about 0.1 to about 0.2 weight %.

Embodiment 15: The method of any one of embodiments 1-14, wherein the rubber (iii) is a polymer or copolymer made from at least one conjugated diene-based monomer selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene and 2,4-hexadiene, and optionally from at least one vinyl aromatic monomer selected from the group consisting of styrene, α-methyl styrene, p-methylstyrene, o-methylstyrene, p-butylstyrene, vinylnaphthalene, and combinations thereof.

Embodiment 16: The method of embodiment 15, wherein the conjugated diene is 1,3-butadiene.

Embodiment 17: The method of embodiment 15, wherein the conjugated diene is 1,3-butadiene and the aromatic vinyl monomer is styrene.

Embodiment 18: The method of any one of embodiments 1-17, wherein the rubber (ii) is selected from the group consisting of styrene-butadiene rubber, polybutadiene rubber, polyisoprene rubber, and mixtures thereof.

Embodiment 19: The method of embodiment 18, wherein the rubber (ii) includes functionalized high-cis polybutadiene rubber, preferably high-cis polybutadiene rubber functionalized with a carbon black-reactive functional group.

Embodiment 20: The method of any one of embodiments 1-19, wherein the eutectic composition comprises a combination of a cationic source selected from the group consisting of ammonium compounds, phosphonium compounds, sulfonium compounds, and combinations thereof, and an anionic source selected from the group consisting of metal halide compounds, metal halide hydrate compounds, hydrogen bond donor compounds, and combinations thereof.

Embodiment 21: The method of embodiment 20, wherein the cationic source is selected from the group consisting of ammonium compounds, preferably selected from at least one of the following: (i) an ammonium compound having formula II: (R¹)(R²)(R³)(R⁴)—N⁺-Φ⁻ where each R¹, R², R³ and R⁴ is independently selected from hydrogen and monovalent organic groups, and two of R¹, R², R³ and R⁴ may be joined to form a divalent organic group and Φ⁻ is a counter anion; (ii) an ammonium compound having formula IV, preferably selected from the group consisting of N-ethyl-2-hydroxy-N,N-dimethylethanaminium chloride, 2-hydroxy-N,N,N-trimethylethanaminium chloride, and N-benzyl-2-hydroxy-N,N-dimethylethanamine chloride, and combinations thereof; or (iii) an ammonium compound having formula III, preferably selected from the group consisting of 2-chloro-N,N,N-trimethylethanaminium, and 2-(chlorocarbonyloxy)-N,N,N-trimethylethanaminium chloride, and combinations thereof.

Embodiment 22: The method of embodiment 20 or 21, wherein the anionic source is selected from the group consisting of hydrogen bond donor compounds, preferably selected from at least one of the following: (i) amines, amides, carboxylic acids, alcohols, and mixtures thereof; (ii) amines, preferably selected from aliphatic amines, ethylenediamine, diethylenetriamine, aminoethylpiperazine, triethylenetetramine, tris(2-aminoethyl)amine, N,N′-bis-(2aminoethyle)piperazine, piperazinoethylethylenediamine, and tetraethylenepentaamine, propyleneamine, aniline, substituted aniline, and combinations thereof; (iii) amides, preferably selected from urea, 1-methyl urea, 1,1-dimethyl urea, 1,3-dimethylurea, thiourea, benzamide, acetamide, and combinations thereof; (iv) carboxylic acids, preferably selected from phenylpropionic acid, phenylacetic acid, benzoic acid, oxalic acid, malonic acid, adipic acid, succinic acid, citric acid, tricarballylic acid, and combinations thereof; or (v) alcohols, preferably selected from aliphatic alcohols, phenol, substituted phenol, ethylene glycol, propylene glycol, resorcinol, substituted resorcinol, glycerol, benzene triol, and combinations thereof.

Embodiment 23: The method of embodiment 20 or embodiment 21, wherein the anionic source is selected from the group consisting of metal halides, preferably selected from the group consisting of aluminum chloride, aluminum bromide, aluminum iodide, zinc chloride, zinc bromide, zinc iodide, tin chloride, tin bromide, tin iodide, iron chloride, iron bromide, iron iodide, and combinations thereof.

Embodiment 24: The method of any one of embodiments 1-23, wherein the eutectic composition comprises a combination of choline chloride and urea.

Embodiment 25: The method of any one of embodiments 1-24, wherein the tire component is a tire tread having at least one of the following physical properties: (a) an elongation at break at 23° C. that is higher, preferably at least 3% higher, than a comparative cured rubber composition substituting Hevea natural rubber for the guayule natural rubber; (b) a tensile strength (Tb) at 23° C. that is higher, preferably at least 5% higher, than a comparative cured rubber composition substituting Hevea natural rubber for the guayule natural rubber, or (c) a rolling resistance, as evidenced by tan delta at 60° C. that is lower, preferably at least 3% lower, than a comparative cured rubber composition substituting Hevea natural rubber for the guayule natural rubber.

Embodiment 26: The method of embodiment 25, wherein the tire component is a tire tread having properties (a)-(c) and also having the following physical property: (d) a modulus selected from M50, M100, M300, and combinations thereof, that is higher, preferably at least 2% higher, than a comparative cured rubber composition substituting Hevea natural rubber for the guayule natural rubber.

Embodiment 27: The method of embodiment 26, wherein each of (a)-(d) are met and the modulus is selected from M50 or M100, preferably M100.

Embodiment 28: The method of any one of embodiments 1-27, wherein the tire component is a tire tread, preferably a tire tread of a truck or bus radial tire, and the cured rubber composition has at least one of the following physical properties: (a) an elongation at break at 23° C. of at least about 250%, preferably about 250% to about 550%; (b) a tensile strength (Tb) at 23° C. of at least about 18 MPa, preferably about 18 MPa to about 35 MPa; (c) a rolling resistance, as evidenced by tan delta at 60° C. of no more than about 0.21, preferably about 0.06 to about 0.21.

Embodiment 29: The method of embodiment 28, wherein the cured rubber composition has properties (a)-(c) and also has the following physical property: (d) a modulus selected from at least one of the following: (i) a M50 of at least about 1.3 MPa, preferably about 1.3 MPa to about 2.5 MPa, (ii) a M100 of at least about 2.3 MPa, preferably about 2.3 MPa to about 5 MPa; or (iii) a M300 of at least about 12 MPa, preferably about 12 MPa to about 22 MPa.

Embodiment 30: The method of embodiment 29, wherein each of (a)-(d) are met and the modulus is selected from M50 or M100, preferably M100.

Embodiment 31: The method of any one of embodiments 1-30 wherein the eutectic composition has been pre-mixed with a solid carrier.

Embodiment 100: A tire component, preferably a tire tread, comprising a rubber composition comprising: (a) 100 parts of at least one rubber including (i) 10-100 parts, preferably 51-90 parts of natural rubber with at least 10% by weight provided by a guayule natural rubber having a Mw of at least 1.2 million grams/mole, preferably 1.25 to 1.35 grams/mole, an Mn of at least 0.25 million grams/mole, preferably 0.3 to 0.4 million grams/mole and a Mw/Mn of 3-4, and (ii) 0-90 parts, preferably 10-49 parts of at least one conjugated diene monomer-based rubber; (b) about 30 to about 150 phr of reinforcing filler selected from carbon black and silica; and (c) a cure package including a sulfur-based vulcanizing agent, at least one vulcanization accelerator, a vulcanization activator, and a eutectic composition or a residue thereof, preferably in an amount of about 0.005 to about 3 phr, more preferably about 0.01 to about 1 phr, wherein (a), (b) and (c) are used in a cured rubber composition to provide the tire component.

Embodiment 101: The tire component of embodiment 100, wherein the tire component is a tire tread.

Embodiment 102: The tire component of embodiment 100 or embodiment 101, wherein 51-90 parts of the natural rubber of (i) is provided by the guayule natural rubber.

Embodiment 103: The tire component of any one of embodiments 100-102, wherein (ii) is present in an amount of 10-49 parts.

Embodiment 104: The tire component of any one of embodiments 100-103, wherein the eutectic composition is present in an amount of about 0.005 to about 3 phr.

Embodiment 105: The tire component of any one of embodiments 100-104, wherein the eutectic composition is present in an amount of about 0.01 to about 1 phr.

Embodiment 106: The tire component of any one of embodiments 100-105, wherein the guayule natural rubber provides at least 20% by weight of the natural rubber.

Embodiment 107: The tire component of any one of embodiments 100-105, wherein the guayule natural rubber provides at least 30% by weight of the natural rubber.

Embodiment 108: The tire component of any one of embodiments 100-105, wherein the guayule natural rubber provides at least 40% by weight of the natural rubber.

Embodiment 109: The tire component of any one of embodiments 100-105, wherein the guayule natural rubber provides a majority by weight of the natural rubber.

Embodiment 110: The tire component of any one of embodiments 100-105, wherein the guayule natural rubber provides at least 70% by weight of the natural rubber.

Embodiment 111: The tire component of any one of embodiments 100-105, wherein the guayule natural rubber, more preferably at least 80% by weight of the natural rubber.

Embodiment 112: The tire component of any one of embodiments 100-105, wherein the guayule natural rubber provides 100% by weight of the natural rubber.

Embodiment 113: The tire component of any one of embodiments 100-112, wherein the guayule natural rubber has a resin content of about 2 to about 5% by weight and an ash content of about 0.1 to about 0.2 weight %.

Embodiment 114: The tire component of any one of embodiments 100-113, wherein the rubber (iii) is a polymer or copolymer made from at least one conjugated diene-based monomer selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene and 2,4-hexadiene, and optionally from at least one vinyl aromatic monomer selected from the group consisting of styrene, α-methyl styrene, p-methylstyrene, o-methylstyrene, p-butylstyrene, vinylnaphthalene, and combinations thereof.

Embodiment 115: The tire component of embodiment 114, wherein the conjugated diene is 1,3-butadiene.

Embodiment 116: The tire component of embodiment 114, wherein the conjugated diene is 1,3-butadiene and the aromatic vinyl monomer is styrene.

Embodiment 117: The tire component of any one of embodiments 100-116, wherein the rubber (ii) is selected from the group consisting of styrene-butadiene rubber, polybutadiene rubber, polyisoprene rubber, and mixtures thereof.

Embodiment 118: The tire component of embodiment 117, wherein the rubber (ii) includes functionalized high-cis polybutadiene rubber, preferably high-cis polybutadiene rubber functionalized with a carbon black-reactive functional group.

Embodiment 119: The tire component of any one of embodiments 100-118, wherein the eutectic composition comprises a combination of a cationic source selected from the group consisting of ammonium compounds, phosphonium compounds, sulfonium compounds, and combinations thereof, and an anionic source selected from the group consisting of metal halide compounds, metal halide hydrate compounds, hydrogen bond donor compounds, and combinations thereof.

Embodiment 120: The tire component of embodiment 119, wherein the cationic source is selected from the group consisting of ammonium compounds, preferably selected from at least one of the following: (i) an ammonium compound having formula II: (R¹)(R²)(R³)(R⁴)—N⁺-Φ⁻ where each R¹, R², R³ and R⁴ is independently selected from hydrogen and monovalent organic groups, and two of R¹, R², R³ and R⁴ may be joined to form a divalent organic group and Φ is a counter anion; (ii) an ammonium compound having formula IV, preferably selected from the group consisting of N-ethyl-2-hydroxy-N,N-dimethylethanaminium chloride, 2-hydroxy-N,N,N-trimethylethanaminium chloride, and N-benzyl-2-hydroxy-N,N-dimethylethanamine chloride, and combinations thereof; or (iii) an ammonium compound having formula III, preferably selected from the group consisting of 2-chloro-N,N,N-trimethylethanaminium, and 2-(chlorocarbonyloxy)-N,N,N-trimethylethanaminium chloride, and combinations thereof.

Embodiment 121: The tire component of embodiment 120, wherein the anionic source is selected from the group consisting of hydrogen bond donor compounds, preferably selected from at least one of the following: (i) amines, amides, carboxylic acids, alcohols, and mixtures thereof; (ii) amines, preferably selected from aliphatic amines, ethylenediamine, diethylenetriamine, aminoethylpiperazine, triethylenetetramine, tris(2-aminoethyl)amine, N,N′-bis-(2aminoethyle)piperazine, piperazinoethylethylenediamine, and tetraethylenepentaamine, propyleneamine, aniline, substituted aniline, and combinations thereof; (iii) amides, preferably selected from urea, 1-methyl urea, 1,1-dimethyl urea, 1,3-dimethylurea, thiourea, benzamide, acetamide, and combinations thereof; (iv) carboxylic acids, preferably selected from phenylpropionic acid, phenylacetic acid, benzoic acid, oxalic acid, malonic acid, adipic acid, succinic acid, citric acid, tricarballylic acid, and combinations thereof; or (v) alcohols, preferably selected from aliphatic alcohols, phenol, substituted phenol, ethylene glycol, propylene glycol, resorcinol, substituted resorcinol, glycerol, benzene triol, and combinations thereof.

Embodiment 122: The tire component of embodiment 120 or 121, wherein the anionic source is selected from the group consisting of metal halides, preferably selected from the group consisting of aluminum chloride, aluminum bromide, aluminum iodide, zinc chloride, zinc bromide, zinc iodide, tin chloride, tin bromide, tin iodide, iron chloride, iron bromide, iron iodide, and combinations thereof.

Embodiment 123: The tire component of any one of embodiments 100-122, wherein the eutectic composition comprises a combination of choline chloride and urea.

Embodiment 124: The tire component of any one of embodiments 100-123, wherein the tire component is a tire tread having at least one of the following physical properties: (a) an elongation at break at 23° C. that is higher, preferably at least 3% higher, than a comparative cured rubber composition substituting Hevea natural rubber for the guayule natural rubber; (b) a tensile strength (Tb) at 23° C. that is higher, preferably at least 5% higher, than a comparative cured rubber composition substituting Hevea natural rubber for the guayule natural rubber; or (c) a rolling resistance, as evidenced by tan delta at 60° C. that is lower, preferably at least 3% lower, than a comparative cured rubber composition substituting Hevea natural rubber for the guayule natural rubber.

Embodiment 125: The tire component of embodiment 124, wherein each of (a)-(c) are met and the tire tread has the additional following property: (d) a modulus selected from M50, M100, M300, and combinations thereof, that is higher, preferably at least 2% higher, than a comparative cured rubber composition substituting Hevea natural rubber for the guayule natural rubber.

Embodiment 126: The tire component of embodiment 125, wherein each of (a)-(d) are met and the modulus is selected from M50 or M100, preferably M100.

Embodiment 127: The tire component of any one of embodiments 100-123, wherein the tire component is a tire tread, preferably a tire tread for a truck or bus radial tire, and the cured rubber composition has at least one of the following physical properties: (a) an elongation at break at 23° C. of at least about 250%, preferably about 250% to about 550%; (b) a tensile strength (Tb) at 23° C. of at least about 18 MPa, preferably about 18 MPa to about 35 MPa; (c) a rolling resistance, as evidenced by tan delta at 60° C. of no more than about 0.21, preferably about 0.06 to about 0.21.

Embodiment 128: The tire component of embodiment 127, wherein the cured rubber composition has properties (a)-(c) and also has the following physical property: (d) a modulus selected from at least one of the following: (i) a M50 of at least about 1.3 MPa, preferably about 1.3 MPa to about 2.5 MPa, (ii) a M100 of at least about 2.3 MPa, preferably about 2.3 MPa to about 5 MPa, or (iii) a M300 of at least about 12 MPa, preferably about 12 MPa to about 22 MPa.

Embodiment 129: The tire component of any one of embodiments 100-128 wherein the eutectic composition has been pre-mixed with a solid carrier.

Embodiment 200: A tire tread, comprising a rubber composition comprising: (a) 100 parts of at least one rubber including (i) 10-100 parts, preferably 51-90 parts of natural rubber with at least 10% by weight provided by a guayule natural rubber having a Mw of at least 1.2 million grams/mole, preferably 1.25 to 1.35 grams/mole, an Mn of at least 0.25 million grams/mole, preferably 0.3 to 0.4 million grams/mole and a Mw/Mn of 3-4, and (ii) 0-90 parts, preferably 10-49 parts of at least one conjugated diene monomer-based rubber; (b) about 30 to about 150 phr of reinforcing filler selected from carbon black and silica; and (c) a cure package including a sulfur-based vulcanizing agent, at least one vulcanization accelerator, a vulcanization activator, and a eutectic composition or a residue thereof, preferably in an amount of about 0.005 to about 3 phr, more preferably about 0.01 to about 1 phr, wherein (a), (b) and (c) are used in a cured rubber composition to provide the tire component.

Embodiment 201: The tire tread of embodiment 200, wherein the tire component is a tire tread.

Embodiment 202: The tire tread of embodiment 200 or embodiment 201, wherein 51-90 parts of the natural rubber of (i) is provided by the guayule natural rubber.

Embodiment 203: The tire tread of any one of embodiments 200-202, wherein (ii) is present in an amount of 10-49 parts.

Embodiment 204: The tire tread of any one of embodiments 200-203, wherein the eutectic composition is present in an amount of about 0.005 to about 3 phr.

Embodiment 205: The tire tread of any one of embodiments 200-204, wherein the eutectic composition is present in an amount of about 0.01 to about 1 phr.

Embodiment 206: The tire tread of any one of embodiments 200-205, wherein the guayule natural rubber provides at least 20% by weight of the natural rubber.

Embodiment 207: The tire tread of any one of embodiments 200-205, wherein the guayule natural rubber provides at least 30% by weight of the natural rubber.

Embodiment 208: The tire tread of any one of embodiments 200-205, wherein the guayule natural rubber provides at least 40% by weight of the natural rubber.

Embodiment 209: The tire tread of any one of embodiments 200-205, wherein the guayule natural rubber provides a majority by weight of the natural rubber.

Embodiment 210: The tire tread of any one of embodiments 200-205, wherein the guayule natural rubber provides at least 70% by weight of the natural rubber.

Embodiment 211: The tire tread of any one of embodiments 200-205, wherein the guayule natural rubber, more preferably at least 80% by weight of the natural rubber.

Embodiment 212: The tire tread of any one of embodiments 200-205, wherein the guayule natural rubber provides 100% by weight of the natural rubber.

Embodiment 213: The tire tread of any one of embodiments 200-212, wherein the guayule natural rubber has a resin content of about 2 to about 5% by weight and an ash content of about 0.1 to about 0.2 weight %.

Embodiment 214: The tire tread of any one of embodiments 200-213, wherein the rubber (iii) is a polymer or copolymer made from at least one conjugated diene-based monomer selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene and 2,4-hexadiene, and optionally from at least one vinyl aromatic monomer selected from the group consisting of styrene, β-methyl styrene, p-methylstyrene, o-methylstyrene, p-butylstyrene, vinylnaphthalene, and combinations thereof.

Embodiment 215: The tire tread of embodiment 214, wherein the conjugated diene is 1,3-butadiene.

Embodiment 216: The tire tread of embodiment 214, wherein the conjugated diene is 1,3-butadiene and the aromatic vinyl monomer is styrene.

Embodiment 217: The tire tread of any one of embodiments 200-216, wherein the rubber (ii) is selected from the group consisting of styrene-butadiene rubber, polybutadiene rubber, polyisoprene rubber, and mixtures thereof.

Embodiment 218: The tire tread of embodiment 217, wherein the rubber (ii) includes functionalized high-cis polybutadiene rubber, preferably high-cis polybutadiene rubber functionalized with a carbon black-reactive functional group.

Embodiment 219: The tire tread of any one of embodiments 200-218, wherein the eutectic composition comprises a combination of a cationic source selected from the group consisting of ammonium compounds, phosphonium compounds, sulfonium compounds, and combinations thereof, and an anionic source selected from the group consisting of metal halide compounds, metal halide hydrate compounds, hydrogen bond donor compounds, and combinations thereof.

Embodiment 220: The tire tread of embodiment 219, wherein the cationic source is selected from the group consisting of ammonium compounds, preferably selected from at least one of the following: (i) an ammonium compound having formula II: (R¹)(R²)(R³)(R⁴)—N⁺-Φ⁻ where each R¹, R², R³ and R⁴ is independently selected from hydrogen and monovalent organic groups, and two of R¹, R², R³ and R⁴ may be joined to form a divalent organic group and Φ is a counter anion; (ii) an ammonium compound having formula IV, preferably selected from the group consisting of N-ethyl-2-hydroxy-N,N-dimethylethanaminium chloride, 2-hydroxy-N,N,N-trimethylethanaminium chloride, and N-benzyl-2-hydroxy-N,N-dimethylethanamine chloride, and combinations thereof; or (iii) an ammonium compound having formula III, preferably selected from the group consisting of 2-chloro-N,N,N-trimethylethanaminium, and 2-(chlorocarbonyloxy)-N,N,N-trimethylethanaminium chloride, and combinations thereof.

Embodiment 221: The tire tread of embodiment 220, wherein the anionic source is selected from the group consisting of hydrogen bond donor compounds, preferably selected from at least one of the following: (i) amines, amides, carboxylic acids, alcohols, and mixtures thereof; (ii) amines, preferably selected from aliphatic amines, ethylenediamine, diethylenetriamine, aminoethylpiperazine, triethylenetetramine, tris(2-aminoethyl)amine, N,N′-bis-(2aminoethyle)piperazine, piperazinoethylethylenediamine, and tetraethylenepentaamine, propyleneamine, aniline, substituted aniline, and combinations thereof; (iii) amides, preferably selected from urea, 1-methyl urea, 1,1-dimethyl urea, 1,3-dimethylurea, thiourea, benzamide, acetamide, and combinations thereof; (iv) carboxylic acids, preferably selected from phenylpropionic acid, phenylacetic acid, benzoic acid, oxalic acid, malonic acid, adipic acid, succinic acid, citric acid, tricarballylic acid, and combinations thereof; or (v) alcohols, preferably selected from aliphatic alcohols, phenol, substituted phenol, ethylene glycol, propylene glycol, resorcinol, substituted resorcinol, glycerol, benzene triol, and combinations thereof.

Embodiment 222: The tire tread of embodiment 220 or 221, wherein the anionic source is selected from the group consisting of metal halides, preferably selected from the group consisting of aluminum chloride, aluminum bromide, aluminum iodide, zinc chloride, zinc bromide, zinc iodide, tin chloride, tin bromide, tin iodide, iron chloride, iron bromide, iron iodide, and combinations thereof.

Embodiment 223: The tire tread of any one of embodiments 200-222, wherein the eutectic composition comprises a combination of choline chloride and urea.

Embodiment 224: The tire tread of any one of embodiments 200-223, wherein the tire tread is for a truck or bus radial tire.

Embodiment 225: The tire tread of any one of embodiments 200-223, wherein the tire tread is for a pneumatic tire, preferably for a passenger car or light truck.

Embodiment 226: The tire tread of any one of embodiments 200-225, having at least one of the following physical properties: (a) an elongation at break at 23° C. that is higher, preferably at least 3% higher, than a comparative cured rubber composition substituting Hevea natural rubber for the guayule natural rubber; (b) a tensile strength (Tb) at 23° C. that is higher, preferably at least 5% higher, than a comparative cured rubber composition substituting Hevea natural rubber for the guayule natural rubber; or (c) a rolling resistance, as evidenced by tan delta at 60° C. that is lower, preferably at least 3% lower, than a comparative cured rubber composition substituting Hevea natural rubber for the guayule natural rubber.

Embodiment 227: The tire tread of embodiment 226, wherein each of (a)-(c) are met and the tire tread has the additional following property: (d) a modulus selected from M50, M100, M300, and combinations thereof, that is higher, preferably at least 2% higher, than a comparative cured rubber composition substituting Hevea natural rubber for the guayule natural rubber.

Embodiment 228: The tire tread of embodiment 227, wherein each of (a)-(d) are met and the modulus is selected from M50 or M100, preferably M100.

Embodiment 229: The tire tread of any one of embodiments 200-228, wherein the tire tread is for a truck or bus radial tire, and the cured rubber composition has at least one of the following physical properties: (a) an elongation at break at 23° C. of at least about 250%, preferably about 250% to about 550%; (b) a tensile strength (Tb) at 23° C. of at least about 18 MPa, preferably about 18 MPa to about 35 MPa; (c) a rolling resistance, as evidenced by tan delta at 60° C. of no more than about 0.21, preferably about 0.06 to about 0.21.

Embodiment 230: The tire tread of embodiment 229, wherein the cured rubber composition has properties (a)-(c) and also has the following physical property: (d) a modulus selected from at least one of the following: (i) a M50 of at least about 1.3 MPa, preferably about 1.3 MPa to about 2.5 MPa, (ii) a M100 of at least about 2.3 MPa, preferably about 2.3 MPa to about 5 MPa, or (iii) a M300 of at least about 12 MPa, preferably about 12 MPa to about 22 MPa.

Embodiment 231: The tire tread of any one of embodiments 200-230 wherein the eutectic composition has been pre-mixed with a solid carrier.

This application discloses several numerical range limitations that support any range within the disclosed numerical ranges, even though a precise range limitation may not be stated verbatim in the specification, because the embodiments of the compositions and methods disclosed herein could be practiced throughout the disclosed numerical ranges. With respect to the use of substantially any plural or singular terms herein, those having skill in the art can translate from the plural to the singular or from the singular to the plural as is appropriate to the context or application. The various singular or plural permutations may be expressly set forth herein for sake of clarity.

It will be understood by those within the art that, in general, terms used herein, and especially in the appended claims are generally intended as “open” terms. For example, the term “including” should be interpreted as “including but not limited to,” the term “having” should be interpreted as “having at least,” the term “includes” should be interpreted as “includes but is not limited to.” It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” All references, including but not limited to patents, patent applications, and non-patent literature are hereby incorporated by reference herein in their entirety. While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

What is claimed is:

1-20. (canceled)

21. A tire component comprising a rubber composition comprising
(a) 100 parts of at least one rubber including (i) 10-100 parts of natural rubber with at least 10% by weight provided by a guayule natural rubber having a Mw of at least 1.2 million grams/mole, an Mn of at least 0.25 million grams/mole, and a Mw/Mn of 3-4, and (ii) 0-90 parts of at least one conjugated diene monomer-based rubber,
(b) about 30 to about 150 phr of reinforcing filler selected from carbon black and silica, and
(c) a cure package including a sulfur-based vulcanizing agent, at least one vulcanization accelerator, a vulcanization activator, and a eutectic composition or a residue thereof in an amount of about 0.005 to about 3 phr,
wherein (a), (b) and (c) are used in a cured rubber composition to provide the tire component.

22. The tire component of claim 21, wherein the guayule natural rubber provides 100% by weight of the natural rubber.

23. The tire component of claim 21, wherein the guayule natural rubber has a resin content of about 2 to about 5% by weight and an ash content of about 0.1 to about 0.2 weight % and a Mooney viscosity (ML1+4 at 100° C.) of at least 65.

24. The tire component of claim 21, wherein the rubber (iii) is a polymer or copolymer made from at least one conjugated diene-based monomer selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene and 2,4-hexadiene, and optionally from at least one vinyl aromatic monomer selected from the group consisting of styrene, α-methyl styrene, p-methylstyrene, o-methylstyrene, p-butylstyrene, vinylnaphthalene, and combinations thereof.

25. The tire component of claim 21, wherein the rubber (ii) is selected from the group consisting of styrene-butadiene rubber, polybutadiene rubber, polyisoprene rubber, and mixtures thereof.

26. The tire component of claim 21, wherein the eutectic composition comprises a combination of a cationic source selected from the group consisting of ammonium compounds, phosphonium compounds, sulfonium compounds, and combinations thereof, and an anionic source selected from the group consisting of metal halide compounds, metal halide hydrate compounds, hydrogen bond donor compounds, and combinations thereof.

27. The tire component of claim 26, wherein the cationic source is selected from the group consisting of ammonium compounds selected from at least one of the following:
i. an ammonium compound having formula II: (R¹)(R²)(R³)(R⁴)—N⁺-Φ⁻ where each R¹, R², R³ and R⁴ is independently selected from hydrogen and monovalent organic groups, and two of R¹, R², R³ and R⁴ may be joined to form a divalent organic group and Φ is a counter anion;
ii. an ammonium compound having formula IV: Φ⁻-(R¹)(R²)(R³)—N⁺—R⁴X where each R¹, R², and R³ is individually selected from hydrogen or a monovalent organic group, or, in the alternative, two of R¹, R², and R³ join to form a divalent organic group, R⁴ is a divalent organic group, X is a halogen atom, and Φ⁻ is a counter anion or
iii. an ammonium compound having formula III: (R¹)(R²)(R³)—N⁺—(R⁴—OH)Φ⁻ where each R¹, R², and R³ is individually selected from hydrogen or a monovalent organic group, or, in the alternative, two of R¹, R², and R³ join to form a divalent organic group, R⁴ is a divalent organic group, and Φ⁻ is a counter anion.

28. The tire component of claim 26, wherein the anionic source is selected from the group consisting of hydrogen bond donor compounds selected from at least one of the following:
i. amines, amides, carboxylic acids, alcohols, and mixtures thereof;
ii. amines selected from aliphatic amines, ethylenediamine, diethylenetriamine, aminoethylpiperazine, triethylenetetramine, tris(2-aminoethyl)amine, N,N′-bis-(2aminoethyle)piperazine, piperazinoethylethylenediamine, and tetraethylenepentaamine, propyleneamine, aniline, substituted aniline, and combinations thereof;
iii. amides selected from urea, 1-methyl urea, 1,1-dimethyl urea, 1,3-dimethylurea, thiourea, benzamide, acetamide, and combinations thereof;
iv. carboxylic acids selected from phenylpropionic acid, phenylacetic acid, benzoic acid, oxalic acid, malonic acid, adipic acid, succinic acid, citric acid, tricarballylic acid, and combinations thereof; or
v. alcohols selected from aliphatic alcohols, phenol, substituted phenol, ethylene glycol, propylene glycol, resorcinol, substituted resorcinol, glycerol, benzene triol, and combinations thereof.

29. The tire component of claim 26, wherein the anionic source is selected from the group consisting of metal halides selected from the group consisting of aluminum chloride, aluminum bromide, aluminum iodide, zinc chloride, zinc bromide, zinc iodide, tin chloride, tin bromide, tin iodide, iron chloride, iron bromide, iron iodide, and combinations thereof.

30. The tire component of claim 21, wherein the eutectic composition comprises a combination of choline chloride and urea.

31. The tire component of claim 21, wherein the tire component is a tire tread having at least one of the following physical properties:
(a) an elongation at break at 23° C. that is at least 3% higher than a comparative cured rubber composition substituting Hevea natural rubber for the guayule natural rubber,
(b) a tensile strength (Tb) at 23° C. that is at least 5% higher than a comparative cured rubber composition substituting Hevea natural rubber for the guayule natural rubber, or
(c) a rolling resistance, as evidenced by tan delta at 60° C. that is at least 3% lower than a comparative cured rubber composition substituting Hevea natural rubber for the guayule natural rubber.

32. The tire component of claim 31, wherein each of (a)-(c) are met and the tire tread has the additional following property:
(d) a modulus selected from M50, M100, M300, and combinations thereof, that is at least 2% higher than a comparative cured rubber composition substituting Hevea natural rubber for the guayule natural rubber.

33. The tire component of claim 32, wherein each of (a)-(d) are met and the modulus is selected from M50 or M100.

34. The tire component of claim 21, wherein the tire component is a tire tread for a truck or bus radial tire, and the cured rubber composition has at least one of the following physical properties:
(a) an elongation at break at 23° C. of at least about 250%,
(b) a tensile strength (Tb) at 23° C. of at least about 18 MPa, or
(c) a rolling resistance, as evidenced by tan delta at 60° C. of no more than about 0.21.

35. The tire component of claim 34, wherein the cured rubber composition has properties (a)-(c) and also has the following physical property
(d) a modulus selected from at least one of the following:
i. a M50 of at least about 1.3 MPa,
ii. a M100 of at least about 2.3 MPa, or
iii. a M300 of at least about 12 MPa.

36. The tire component of claim 21, wherein the eutectic composition has been pre-mixed with a solid carrier.

37. A method for providing the tire component of claim 21, the method comprising utilizing the rubber composition in the tire component.

38. A tire tread comprising a rubber composition comprising
(a) 100 parts of at least one rubber including (i) 51-90 parts of natural rubber with a majority by weight provided by a guayule natural rubber having a Mw of 1.25 to 1.35 million grams/mole, an Mn of 0.3 to 0.4 million grams/mole, and a Mw/Mn of 3-4, and (ii) 0-49 parts of at least one conjugated diene monomer-based rubber,
(b) about 30 to about 150 phr of reinforcing filler selected from carbon black and silica, and
(c) a cure package including a sulfur-based vulcanizing agent, at least one vulcanization accelerator, a vulcanization activator, and a eutectic composition or a residue thereof in an amount of about 0.01 to about 1 phr,
wherein (a), (b) and (c) are used in a cured rubber composition to provide the tire component,
wherein the eutectic composition comprises a combination of choline chloride and urea, and
wherein the guayule natural rubber has a resin content of about 2 to about 5% by weight and an ash content of about 0.1 to about 0.2 weight % and a Mooney viscosity (ML1+4 at 100° C.) of at least 65.

39. The tire tread of claim 38, wherein the tire tread is for a truck or bus radial tire, and the cured rubber composition has each of the following physical properties:
(a) an elongation at break at 23° C. of at least about 250%,
(b) a tensile strength (Tb) at 23° C. of at least about 18 MPa, and
(c) a rolling resistance, as evidenced by tan delta at 60° C. of no more than about 0.21.

40. The tire tread of claim 39, wherein the cured rubber composition has
(d) a modulus according to each of the following:
i. a M50 of at least about 1.3 MPa,
ii. a M100 of at least about 2.3 MPa, and
iii. a M300 of at least about 12 MPa.
